(19) United States
(12) Patent Application Publication
(10) Pub. No.: US 2012/0197889 A1
(43) Pub. Date: Aug. 2, 2012

(54) INFORMATION MATCHING APPARATUS, INFORMATION MATCHING METHOD, AND COMPUTER READABLE STORAGE MEDIUM HAVING STORED INFORMATION MATCHING PROGRAM

(75) Inventor: Kazuo MINENO, Kawasaki (JP)

(73) Assignee: FUJITSU LIMITED, Kawasaki-shi (JP)

(21) Appl. No.: 13/306,433

(22) Filed: Nov. 29, 2011

(30) Foreign Application Priority Data
Jan. 28, 2011 (JP) 2011-017219

(51) Int. Cl. G06F 17/30

(52) U.S. Cl. 707/737; 707/758; 707/748

(57) ABSTRACT

An information matching apparatus includes a target DB corresponding to a check target that stores therein records; a narrow-down condition creating unit that combines, in accordance with values of check items in a check source record using AND, a search condition defined by a search definition indicating a condition for excluding candidates in check target records that are less likely to have a similarity to or a relationship with a name identification source record and each grouping condition defined by a grouping definition indicating a condition for limiting a checking area of the check target records to create a narrow-down condition for narrowing down the check target records; and a searching unit that searches the target DB corresponding to the check target for a check target record in accordance with the created narrow-down condition.

### CROSS-REFERENCE TO RELATED APPLICATION

This application is based upon and claims the benefit of priority of the prior Japanese Patent Application No. 2011-017219, filed on Jan. 28, 2011, the entire contents of which are incorporated herein by reference.

### FIELD

The embodiment discussed herein is directed to an information matching apparatus, an information matching method, and an information matching program.

### BACKGROUND

A name identification (matching) function is used as a function of checking records constituted by a set of values and determining the identity, the similarity, and the relationship between the records. In the matching function, a set of records to be matched are referred to as, for example, a name identification source, whereas a set of records that is the other party of the matching is referred to as, for example, a name identification target. FIG. 14 is a schematic diagram illustrating a matching function. As illustrated in FIG. 14, a name identification process that implements the matching function detects, from the name identification target, a record identical to that in the name identification source, a record similar to that in the name identification source, or a record related to that in the name identification source and outputs a detection result as a matching result.

For the matching function of customer information, there is a disclosed technology for searching a matching database (DB) for customer information in accordance with customer data obtained by formatting address information and name information; narrowing down checking data; and comparing the checking data with the customer data. With this technology, in a function of comparing the narrowed down checking data with the customer data that corresponds to the name identification source, the degree of matching is determined, and, if the customer data is determined to be customer data on a new customer in accordance with the degree of the matching, the customer data is newly registered in the matching DB that is the name identification target.
Patent Document 1: Japanese Laid-open Patent Publication No. 2004-348489

In recent years, a technology for matching databases at high speed is needed as the volume (scale) of the databases becomes large. An operation of the conventional matching function will be described with reference to FIG. 15. FIG. 15 is a schematic diagram illustrating an operation of the matching function. As illustrated in FIG. 15, the name identification process that implements the matching function matches a record J1 stored in the name identification source with records M (M1 to Mn) stored in the name identification target.

First, by using an evaluation function previously prescribed for each name identification item, the name identification process checks a value of each item (hereinafter, referred to as a “name identification item”) that is used to match the record J1 in the name identification source and the record M1 in the name identification target. Here, the name identification items are assumed to be a name, an address, and a date of birth. The name identification process performs the checking by using evaluation functions, in which, from among the name identification items, the name is used as fa( ) the address is used as fb( ) and the date of birth is used as fc( ). Then, the name identification process assigns weights to, for each name identification item, evaluation values of the name identification items derived as the check results and adds the obtained values, thereby obtaining a comprehensive evaluation value. Furthermore, the name identification process obtains comprehensive evaluation values of all of the records M2 to Mn remaining in the name identification target with respect to the record J1 in the name identification source. The name identification process creates a matching candidate set containing the comprehensive evaluation value by creating combinations of the record J1 stored in the name identification source and the records M1 to Mn stored in the name identification target.

Then, in accordance with the previously prescribed threshold or the determination rule, the name identification process performs the determination related to matching a combination of records belonging to the matching candidate set. For example, the name identification process automatically performs the determination by specifying a combination of records that completely match as “White” and specifying a combination of records that do not completely match as “Black” and outputs the matching results. The name identification process outputs, as “Gray” to a candidate list, a combination of records that is not automatically determined. Then, a person determines the combination that is output to the candidate list. A name identification definition needed to be set by a person includes a selection of name identification items, a selection of evaluation functions, and the setting of weights and thresholds.

In the following, a specific example of the name identification process will be described with reference to FIGS. 16 and 17. FIG. 16 is a schematic diagram illustrating an example of the data structure of a name identification definition. FIG. 16(A) illustrates the content of the name identification definition. FIG. 16(B) illustrates a specific example of the name identification definition. FIG. 17 is a schematic diagram illustrating a specific example of the matching.

As illustrated in FIG. 16(A), the name identification definition is defined by associating a matching method d1, name identification source specification d2, a name identification target specification d3, a matching item specification d4, and a threshold d5. In the matching method d1, a matching method is specified. For example, the matching method has a “self name identification (self matching)” function of matching a single record in a round robin manner; detecting a matching record; and deleting duplicate records. In the self name identification, because the name identification source and the name identification target are in the same set, the structures thereof (record items) are the same. Furthermore, the matching method also has a “different party name identification (different-item matching)” function of matching different set of records stored in the name identification source and the name identification target that are used as a combination of the name identification source record and the name identification target record; detecting a matching record; and associating the corresponding records. In the different party name identification, because the name identification source and the name identification target are different sets, the structures thereof (record items) differ. In the name identification source specification d2, access information, such as a database name of the name identification source, and record items of the name identification source are specified. In the name identification target specification d3, access information, such as a database name of the name identification target, and record items of the name identification target are specified. In the matching item specification d4, the matching items are specified as combinations of name identification source items and name identification target items. An evaluation function and the weight used for each matching item are specified. In the threshold d5, a higher threshold that is used to determine “White” and a lower threshold that is used to determine “Black” are specified.

As illustrated in FIG. 16(B), for example, the “self name identification” is specified in the matching method d1. A “customer table” is specified in the access information stored in the name identification source specification d2. Items of an identification (ID), a name, a zip code, an address, and a date of birth are specified in the record information stored in the name identification source specification d2. If the “self name identification” is used for the matching method, because the name identification target specification d3 contains the same record information as that stored in the name identification source specification d2, a definition is not needed. In the matching item specification d4, the matching items are specified as name:name, zip code:zip code, address:address, and date of birth:date of birth. They are obtained by specifying a matching item as a combination of an item stored in the name identification source and an item stored in the name identification target. Accordingly, if the “self name identification” is used for the matching method, the record structures of the name identification source and the name identification target are the same, and thus item names are usually the same. An evaluation function and the weight used for each matching item are specified. For example, if the matching item is name:name, an “edit distance” is specified as the evaluation function and 0.3 is specified as the weight. If the matching item is zip code:zip code, a “complete matching” is specified as evaluation function, and 0.2 is specified as the weight. In the threshold d5, 0.72 is specified as a higher threshold, and 0.26 is specified as a lower threshold. The “edit distance” mentioned here is an evaluation function in which the minimum number of edits is represented as the distance when values of matching items stored in the name identification source and in the name identification target are matched and when a value of the name identification target is transformed to a value of the name identification source. For example, if the transformation is not needed, 1.0 is returned; if the transformation is needed to all of the values, 0 is returned; and if the transformation is needed to a part of the values, a value from 0 to 1.0 is returned in accordance with the number of transformation. The “complete matching” mentioned here is an evaluation function that represents whether two values completely match when values of matching items stored in the name identification source and in the name identification target are matched. If two values completely match, 1.0 is returned, whereas if two values do not completely match, 0 is returned. The evaluation function also includes, in addition to the above, for example, an “N-gram” that is used to evaluate the ratio of name identification source values represented by N neighboring characters to name identification targets.

FIG. 17 illustrates, as a part of the name identification process defined in FIG. 16, an intermediate step of the name identification process performed on a single record M1 stored in the name identification source with respect to the name identification target and the result thereof. In a customer table M in the name identification target, for example, two million records are stored therein. The name identification process matches the record M1 stored in the name identification source with each of the records stored in the name identification target. For example, as an intermediate result of the name identification process, the name identification process outputs an application result of the evaluation function, a weighting result, and a comprehensive evaluation value for each combination of the record M1 stored in the name identification source and each of the records M1 to M6 stored in the name identification target. Then, after matching, the name identification process performs the determination of matching for each set of the record M1 stored in the name identification source and the records M1 to M6 stored in the name identification target and then outputs a determination result.

However, when performing large-scale matching, in the conventional name identification process, there is a problem in that the checking of matching takes a long time. Specifically, in the conventional name identification process, all of the records stored in the name identification source and the name identification target are checked in a round robin manner. Accordingly, for example, when the self name identification is used and when two million records are stored in each of the name identification source and the name identification target, the checking is needed for 200 million records×200 million records=4 trillion combinations of records, resulting in a vast amount of time is needed for the name identification process.

Accordingly, in the large-scale matching, for the records stored in the name identification source and the name identification target, an attempt has been made to reduce the number of combinations of records to be checked before checking the records. The above disclosed technology is proposed by aiming at the matching of customer data, in which checking data are narrowed down from the customer information corresponding to the name identification target in accordance with the customer data obtained by formatting the address information and the name information. However, with this technology, all of the records stored in the name identification target are previously needed to be formatted in a state in which expected searches are available, and furthermore, the searching that conforms to a condition is performed; therefore, there may be a case in which, if there is an error in a formatting process, erroneous results are obtained. Furthermore, only the customer data that has address and name items is matched, which is not widely used. Furthermore, because a narrow-down condition is previously determined in accordance with the empirical rule, a narrow-down effect is not always obtained. For example, if the amount of customer data that corresponds to narrow-down search condition is large, the number of records in the narrowed-down checking data is large. Accordingly, in the name identification process, the combinations of the records to be checked are not properly reduced, thus taking a vast amount of time for the checking.

### SUMMARY

According to an aspect of an embodiment of the invention, an information matching apparatus includes a processor, a check target database that stores therein the records, and a memory. The processor executes creating a narrow-down condition for narrowing down check target records by combining, using a logical multiplication in accordance with values of check items contained in a check source record, a search condition defined by a search definition indicating a condition for excluding candidates that are stored in check target records and that are less likely to have a similarity to or a relationship with a check source record, and a grouping condition defined by a grouping definition indicating a condition for limiting a checking area of the check target records; and searching, in accordance with the narrow-down condition created at the creating, the check target database for a check target record.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating the configuration of an information matching apparatus according to an embodiment;

FIG. 2 is a schematic diagram illustrating an example of the data structure of a grouping definition;

FIG. 3 is a schematic diagram illustrating an example of the data structure of a search definition;

FIG. 4 is a flowchart illustrating the flow of an overall name identification process;

FIG. 5 is a flowchart illustrating the flow of a two-step narrow-down process performed in the name identification process according to the embodiment;

FIG. 6 is a flowchart illustrating the flow of a narrow-down condition creating process according to the embodiment;

FIG. 7 is a schematic diagram illustrating an example of an operation for creating a narrow-down condition according to the embodiment;

FIG. 8 is a schematic diagram illustrating an example of an operation for creating the narrow-down condition when a narrow-down condition template according to the embodiment is created;

FIGS. 9A and 9B are schematic diagrams illustrating an example of a search according to the embodiment;

FIG. 10 is a schematic diagram illustrating an example of an ordering search according to the embodiment;

FIG. 11 is a schematic diagram illustrating an example of another ordering search according to the embodiment;

FIG. 12 is a schematic diagram illustrating the effect of two-step narrowing down according to the embodiment;

FIG. 13 is a block diagram illustrating a computer that executes an information matching program;

FIG. 14 is a schematic diagram illustrating a matching function;

FIG. 15 is a schematic diagram illustrating an operation of the matching function;

FIG. 16 is a schematic diagram illustrating an example of the data structure of a name identification definition;

FIG. 17 is a schematic diagram illustrating a specific example of the matching;

FIG. 18 is a schematic diagram illustrating the matching performed by using a “rough narrow down” function;

FIG. 19 is a flowchart illustrating the flow of a name identification process performed by using the rough narrow down function;

FIG. 20 is a flowchart illustrating the flow of a checking process;

FIG. 21 is a schematic diagram illustrating an example of the data structure of a rough narrow-down definition;

FIG. 22 is a schematic diagram illustrating a specific example of the matching performed by using the rough narrow down function;

FIG. 23 is a schematic diagram illustrating an example of the matching using the “grouping window” technique;

FIG. 24 is a schematic diagram illustrating an example of the grouping window technique;

FIG. 25 is a flowchart illustrating the flow of the name identification process using the grouping window technique;

FIG. 26 is a schematic diagram illustrating an example of the data structure of a grouping window definition;

FIG. 27A is a schematic diagram illustrating a specific example of the grouping window technique; and

FIG. 27B is a schematic diagram illustrating a specific example of the matching performed after grouping windows.

### DESCRIPTION OF EMBODIMENT

Preferred embodiments of the present invention will be explained with reference to accompanying drawings. In the embodiment described below, a description will be given with the assumption that the information matching apparatus is used for large-scale matching. Before describing the embodiment, a technology for speeding up the large-scale matching will be described. The present invention is not limited to the embodiment described below.

Technology for Speeding Up Matching Using Rough Narrow Down

There is a technology for speeding up a large-scale name identification process for matching records stored in a name identification source with records stored in a name identification target by reducing combinations of records to be checked before performing a checking process on the records. In the following, a description will be given of a “rough narrow down” technology for roughly narrowing down, which is performed before the checking process, records that are stored in the name identification target and that possibly match a record in the name identification source.

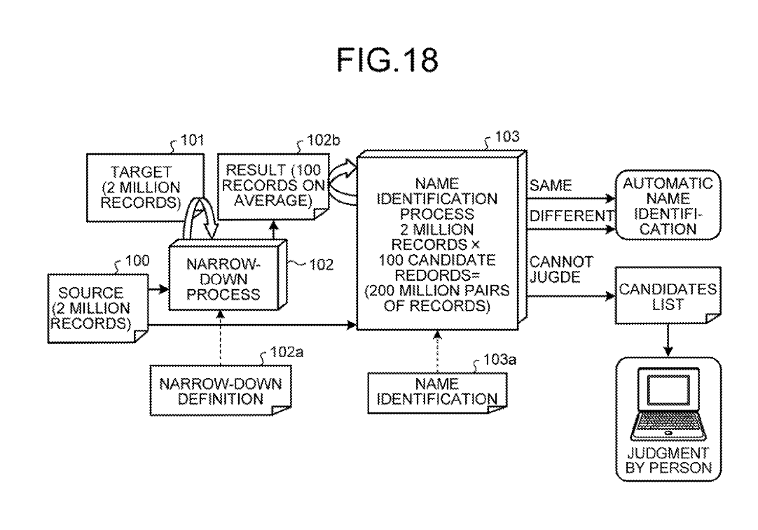

FIG. 18 is a schematic diagram illustrating the matching performed by using a “rough narrow down” function. As illustrated in FIG. 18, by using a search condition created for each record in a name identification source 100, a narrow down process 102 that performs the rough narrowing down searches a name identification target 101 for a record and outputs a result of the search as a result 102b. The search condition is created in accordance with a rough narrow-down definition 102a, which will be described later.

Here, if the number of records in the results 102b, which will become name identification target candidates, is assumed to be, an average of 100 records with respect to one record in the name identification source 100, a name identification process 103 checks 2 million records in the name identification source 100×an average of 100 name identification target candidates=200 million combinations of records. This sharply reduces the checking compared with 4 trillion combinations of records when checking the name identification target 101 in a round robin manner without processing anything.

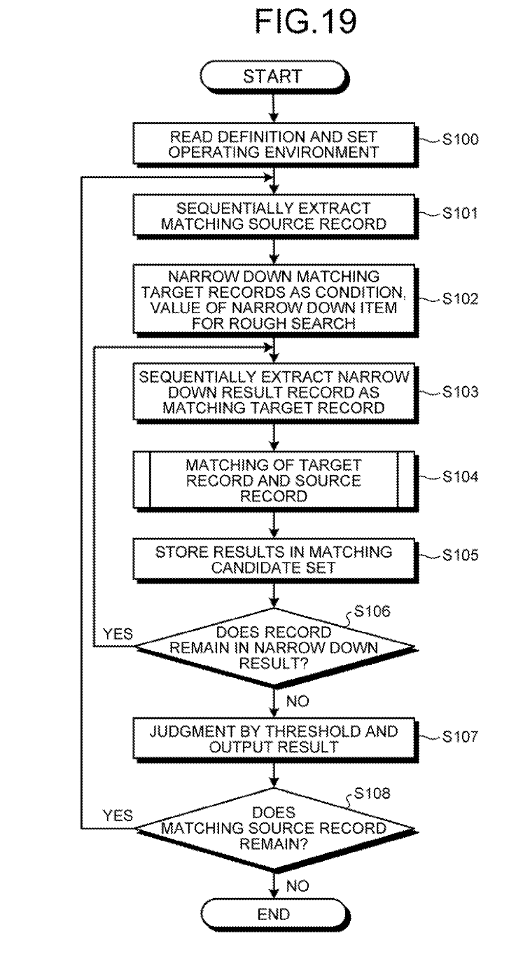

In the following, the flow of a name identification process using the rough narrow down function will be described with reference to FIG. 19. FIG. 19 is a flowchart illustrating the flow of a name identification process performed by using the rough narrow down function.

First, the narrow down process 102 reads the rough narrow-down definition 102a; sets an operating environment (Step S100); and sequentially extracts, from the name identification source 100, a record that is stored in the name identification source and that is to be matched (hereinafter, referred to as a “name identification source record”) (Step S101). Then, for each item defined by the rough narrow-down definition 102a, the narrow down process 102 roughly searches the name identification target 101 using, as a condition, a value of a target item stored in the name identification source record (Step S102). Specifically, for each item, the narrow down process 102 searches the name identification target 101 using a fuzzy search and using an OR search condition in which a value of a target item stored in the name identification source record is used as a condition. The fuzzy search mentioned here is, for example, an “N-gram” search. Then, the narrow down process 102 stores the searched record as the result 102b.

Thereafter, the name identification process 103 sequentially extracts records stored in the result 102b as the name identification target records (Step S103) and checks the name identification source record against the name identification target (Step S104). Then, the name identification process 103 stores a check result in a matching candidate set (Step S105). A comprehensive evaluation value is included in the check result.

Subsequently, the name identification process 103 determines whether a search result record remains in the result 102b (Step S106). If a search result record remains in the result 102b (Yes at Step S106), the name identification process 103 proceeds to Step S103 in order to extract a remaining search result record.

In contrast, if it is determined that a search result record does not remain in the result 102b (No at Step S106), the name identification process 103 performs the determination, using a threshold, on each comprehensive evaluation value stored in the matching candidate set and outputs a determination result (Step S107). For example, if a comprehensive evaluation value is equal to or greater than a higher threshold, the name identification process 103 determines that the combination of the checked name identification source record and the name identification target record is a combination of matched records and determines that the combination of the checked records is “White”. Furthermore, if a comprehensive evaluation value is less than the higher threshold and is equal to or greater than a lower threshold, the name identification process 103 determines that the combination of the checked name identification source record and the name identification target record is not automatically determined and determines that the combination of the checked records is “Gray”. Furthermore, if a comprehensive evaluation value is less than the lower threshold, the name identification process 103 determines that the combination of the checked name identification source record and the name identification target record is a combination of records that do not match and determines that the combination of the checked records is “Black”. The name identification process 103 may also output, to the result 102b, a determination result indicating other than “Black”. Because the combination of the records of the determination result indicating “Black” is determined to be a combination of records other than that of the determination result indicating “White” and “Gray”, the determination result indicating “Black” does not need to be output to the result 102b. Furthermore, there may be a case in which, by separating an output of the result of “White” from that of “Gray”, a result of “Gray” is on a “candidate list” as a determination candidate performed by a person.

Then, the narrow down process 102 determines whether a name identification source record remains in the name identification source 100 (Step S108). If it is determined that a name identification source record remains in the name identification source 100 (Yes at Step S108), the narrow down process 102 proceeds to Step S101 in order to extract the remaining name identification source record. In contrast, if a name identification source record does not remain in the name identification source 100 (No at Step S108), the narrow down process 102 ends the name identification process using the rough narrow down.

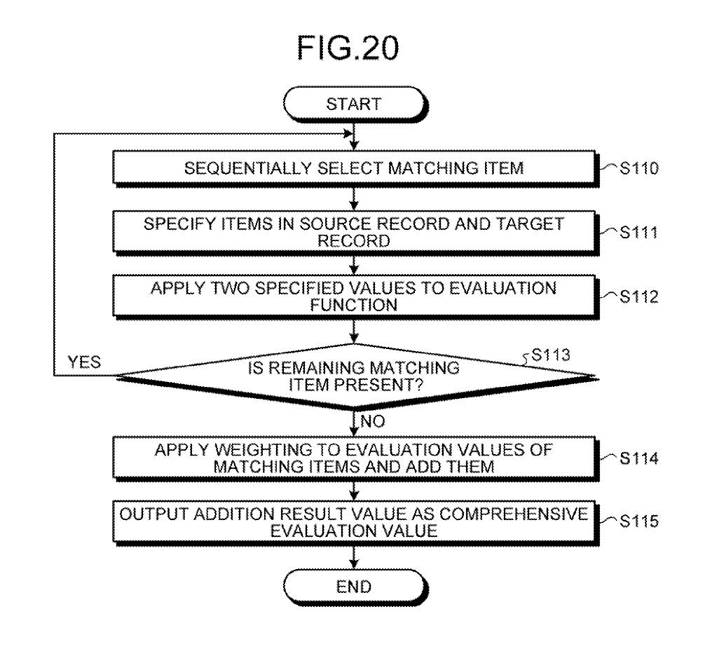

In the following, the flow of the process at 5104 illustrated in FIG. 19 will be described with reference to FIG. 20. FIG. 20 is a flowchart illustrating the flow of a checking process. The checking process is a process to perform the checking, for each combination of a name identification source record and a name identification target record, and derives a comprehensive evaluation value.

First, the name identification process 103 sequentially selects matching items defined by a name identification definition 103a (Step S110). It is assumed that the name identification items are previously defined by the name identification definition 103a as pairs of target items for the comparison between the items stored in the name identification source and the items stored in the name identification target. Then, for a name identification source record and a name identification target record, the name identification process 103 specifies values associated with the selected name identification items (Step S111); applies an evaluation function to the specified two values (Step S112); and calculates an evaluation value. The evaluation function is a function that is previously prescribed for the name identification item and is assumed to be defined by the name identification definition 103a.

Subsequently, the name identification process 103 determines whether a name identification item remains (Step S113). If it is determined that a name identification item remains (Yes at Step S113), the name identification process 103 proceeds to Step S110 in order to apply the evaluation function to the remaining name identification item.

In contrast, if it is determined that a name identification item does not remain (No at Step S113), the name identification process 103 applies, for each name identification item, weighting to evaluation values of name identification items and adds each of the evaluation value subjected to the weighting (Step S114). Then, the name identification process 103 outputs a value of the addition result as a comprehensive evaluation value of the combination of the target record (Step S115), thus ending a checking process for one combination.

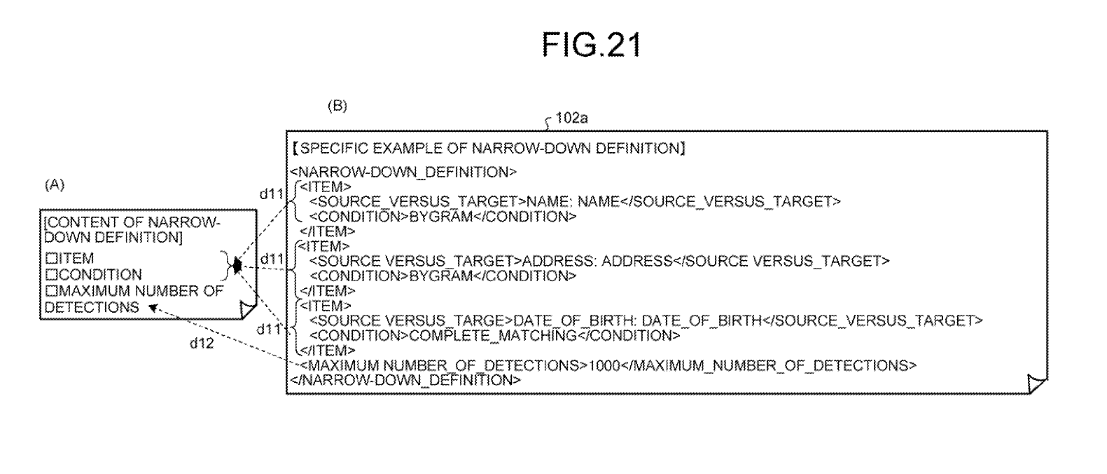

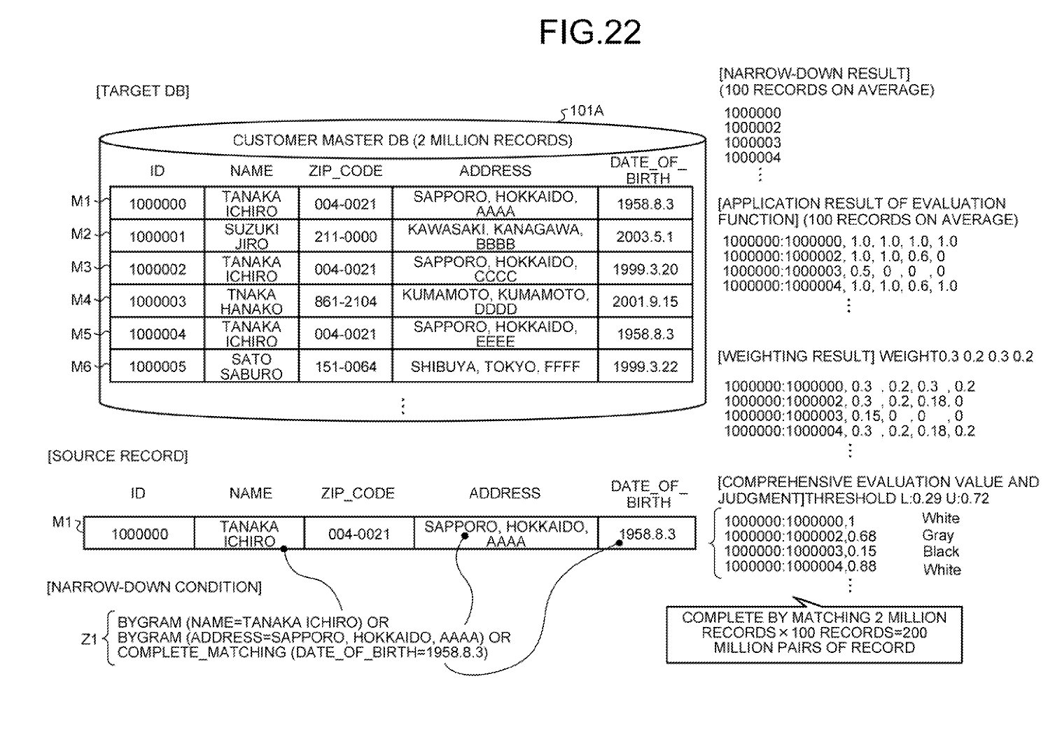

In the following, a specific example of the name identification process using the rough narrow down will be described with reference to FIGS. 21 and 22. FIG. 21 is a schematic diagram illustrating an example of the data structure of a rough narrow-down definition. FIG. 21(A) illustrates the content of a rough narrow-down definition. FIG. 21(B) illustrates a specific example of the rough narrow-down definition. FIG. 22 is a schematic diagram illustrating a specific example of the matching performed by using the rough narrow down function.

As illustrated in FIG. 21(A), in the rough narrow-down definition, a item and a condition are defined in an associated manner, and, in addition, the maximum number of detections is defined as needed. A plurality of items can be specified as a combination of an item stored in the name identification source and an item stored in the name identification target used for the condition in the narrow-down process and conditions corresponding to the items are specified. The maximum number of detections indicates the maximum number of name identification target records to be left as the search results of the name identification target with respect to a single name identification source record.

As illustrated in FIG. 21(B), in the narrow-down definition 102a, an item stored in the name identification source and an item stored in the name identification source that are to be used for each item d11 are defined; a condition is defined; and the maximum number of detections d12 described above is defined. In the item d11, a “source versus” is associated with a “condition”. The “source versus” indicates, as “name identification source item:name identification target item”, item names stored in the name identification source record and in the name identification target record that are to be used as items. The condition specifies, for each item, a search method used when searching for a item in the name identification target using a value of the item in the name identification source. For example, the condition includes a “BYGRAM” that is used to search for a name identification target record containing a item that includes any two letters containing consecutive number of the item stored in the name identification source record or a “complete matching” that is used to search for a name identification target record containing a item whose value completely matches a value of a item in the name identification target record. In the example illustrated in FIG. 21(B), the condition in which the items are “name:name” and “address:address” are the “BYGRAM”, whereas the condition, in which the item is “date of birth:date of birth” is the “complete matching”. Furthermore, the maximum number of detections for each name identification source record is 1000.

FIG. 22 illustrates, as a part of the name identification process using the rough narrowing down, an intermediate step of the name identification process performed on a single name identification source record M1 stored in the name identification source and a result thereof. A customer table 101A corresponding to the name identification target stores therein, for example, two million records. Then, in accordance with the narrow-down definition 102a, for each item, the narrow down process 102 creates, using a value of a item stored in the name identification source record M1 as a condition, a narrow down condition Z1, which is obtained by performing OR on each condition represented by a “search method (name identification target item name=name identification source item value)”, for searching a item stored in the name identification target record. Here, “BYGRAM(name=Tanaka Ichiro) OR BYGRAM(address=Sapporo, Hokkaido, AAAA) OR complete matching (date of birth=1958.8.3)” as the condition Z1. Then, the narrow down process 102 searches the customer table 101A, which is the name identification target, using the created search condition Z1 and outputs, to the result 102b, a name identification target record corresponding to the search result as a result of the narrow down with respect to the name identification source record M1. If the maximum number of detections is prescribed in the narrow-down definition 102a, the narrow down process 102 selects, from among the searched records, records of the maximum number of detections (1000 records in the example illustrated in FIG. 21(B)) defined by the narrow-down definition 102a and outputs a result as the result 102b. For example, in this case, the narrow down process 102 outputs 100 records, on average, as the result 102b, i.e., as the result of the rough narrow down. In FIG. 22, only IDs stored in the name identification target record are illustrated as the results of the narrow down.

Then, the name identification process 103 performs the checking process between the name identification source record M1 and each record stored in the result 102b as the name identification target. For example, as an intermediate result of the checking process, for each combination of the name identification source record M1 and each of the records M1, M3, M4, and MS . . . in the name identification target, the name identification process 103 associates application results of evaluation functions, weighting results, and comprehensive evaluation values and outputs them. Then, after the checking, the name identification process 103 performs the judgment related to the matching for each combination of the name identification source record M1 and each of the records M1, M3, M4, and MS . . . stored in the name identification target and outputs the determination results.

As described above, in the name identification process using the rough narrow down, for example, if it is assumed that the self name identification in which the name identification source versus the name identification target are in the same record group is used; that 2 million records to be matched are stored in the name identification source and the name identification target; and that an average of 100 records remain per one record stored in the name identification source as the result of the rough narrow down, the matching of 2 million records×100 records=200 million combinations of records is performed in the checking process. As described above, if the matching is performed on all of the records without using the rough narrow down, the checking is needed for 2 million records×2 million records=4 trillion combinations of records in the checking process, the name identification process performed by using the rough narrow down checks approximately 1/20,000 records that are stored in the name identification source and in the name identification target when compared with a case in which all of the records stored in the name identification source and in the name identification target are checked in a round robin manner, thus speeding up the checking related to the matching.

In the name identification process using the rough narrow down, large-scale matching is implemented by roughly narrowing down records, for each name identification source record, that possibly match the records stored in the name identification target and by checking the narrowed down name identification target against the name identification source record. However, in addition to the name identification process using the rough narrow down, the name identification process includes a “grouping window” technique that speeds up large-scale matching. This method is used for the self name identification, in which, before performing the name identification process, records to be matched are divided into groups in accordance with an item value (window) that is previously set and the checking is performed only in the divided group, thus implementing the large-scale matching at high speed.

Technology for Speeding Up Matching Using a Grouping Window Technique

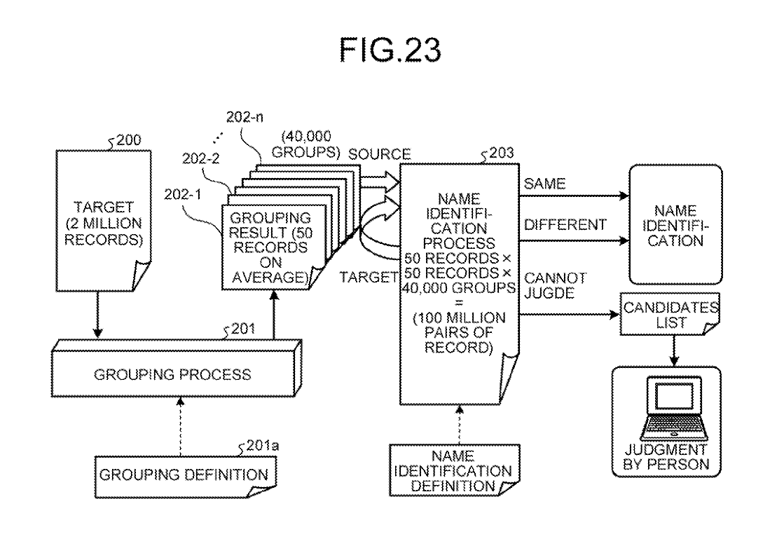

FIG. 23 is a schematic diagram illustrating an example of the matching using the “grouping window” technique. As illustrated in FIG. 23, a grouping process 201, which groups windows, splits targets 200 into multiple groups in accordance with a grouping definition 201a in which items used for the grouping are defined. Then, the grouping process 201 outputs the split groups as grouping results 202-1 to n (n is a natural number). The grouping definition 201a will be described in detail later. The matching that uses the grouping window technique is used for the self name identification in which items stored in the records in the name identification source and in the name identification target are the same.

For example, by grouping target 200 (two million records) into the grouping results 202-1 to n constituted by 40,000 groups, the grouping process 201 reduces the number of average records in each group to an average of 50. In this case, a name identification process 203 checks all of the records for each group, thus checking 50 records×50 records×40,000 groups=100 million combinations of records.

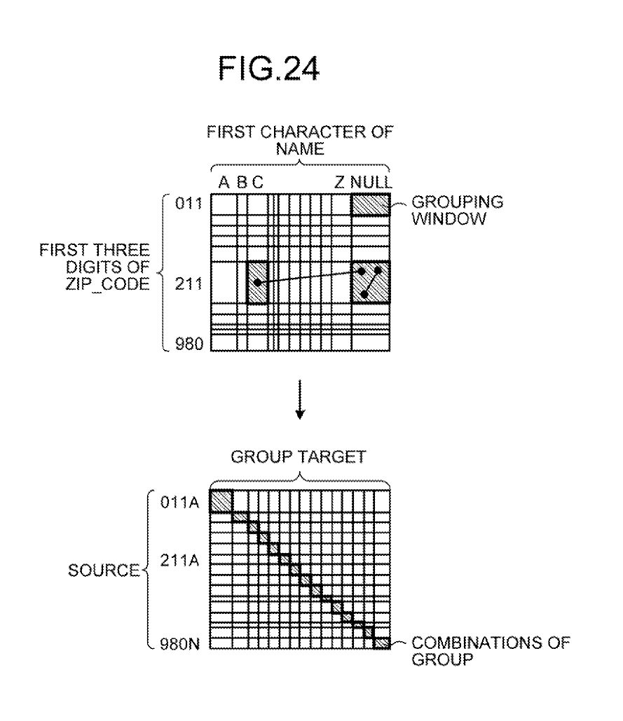

In the following, the grouping window will be described with reference to FIG. 24. FIG. 24 is a schematic diagram illustrating an example of the grouping window technique. As illustrated in FIG. 24, the window that is used for grouping windows is a combination of all or a part of values of multiple items. In the example illustrated in FIG. 24, the grouping process 201 performs the grouping windows in which a value of a combination of a first three digits of a zip code and a value of a first character of a kana name is used as a window. Then, the name identification process 203 performs the matching in the same window in a group instead of matching the different windows in a group. For example, the name identification process 203 performs the matching only on a window “211A” in a group, which is a combination of “211” that are the first three digits of a zip code and “A” that is the first character of the kana name. In contrast, the name identification process 203 does not perform the matching between a group, in which “211” that are first three digits of a zip code and “A” that is the first character of the kana name are combined, and a group, in which “211” that are the first three digits of a zip code and “NULL” that is the first character of the kana name are combined. Accordingly, the matching is not performed between the records stored in the different windows.

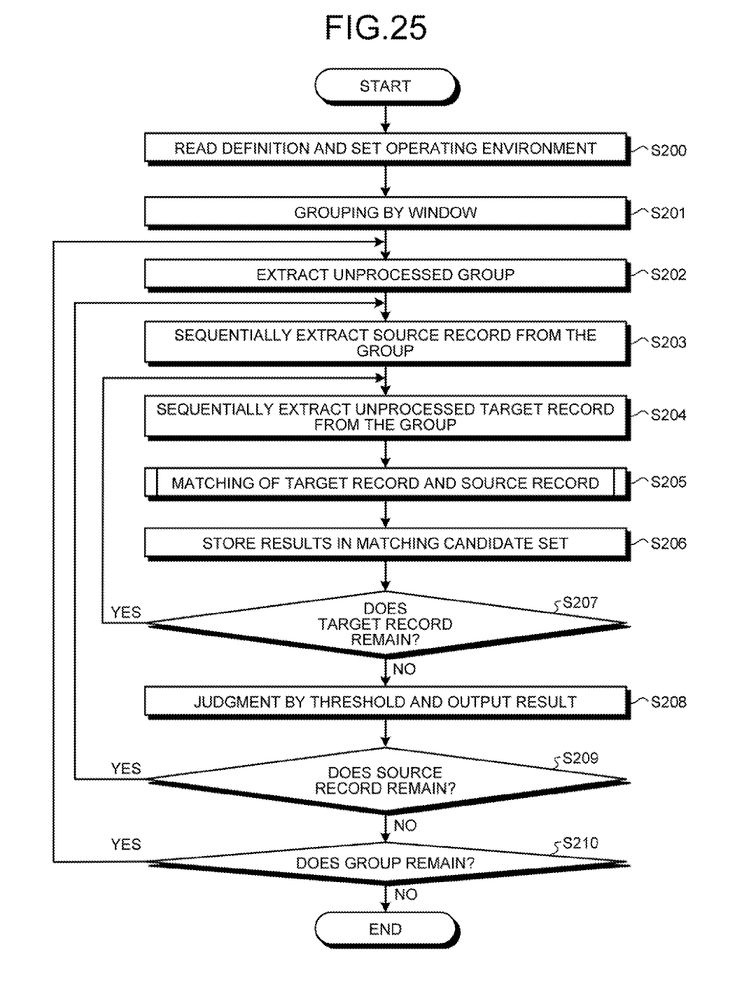

In the following, the flow of the name identification process using the grouping window technique will be described with reference to FIG. 25. FIG. 25 is a flowchart illustrating the flow of the name identification process using the grouping window technique.

First, the grouping process 201 reads the grouping definition 201a, sets an operating environment (Step S200), and groups by windows (Step S201). Specifically, in accordance with the read grouping definition 201a, the grouping process 201 groups the target 200 that correspond to the name identification source and the name identification target into multiple groups.

Then, the name identification process 203 extracts an unprocessed group from the multiple groups obtained as the result of the grouping of windows (Step S202). Thereafter, the name identification process 203 sequentially extracts, from among the extracted groups, the name identification source records (Step S203). Furthermore, the name identification process 203 sequentially extracts unprocessed name identification target records that are in the same group of the name identification source record (Step S204).

Then, the name identification process 203 performs the checking process on the name identification source record and the name identification target record (Step S205). The flow of the checking process is the same as that illustrated in FIG. 20; therefore, a description thereof will be omitted here. The name identification process 203 stores the check results in a matching candidate set (Step S206). The check results contain comprehensive evaluation values.

Subsequently, the name identification process 203 determines whether a name identification target record remains in a group (Step S207). If it is determined that a name identification target record remains in a group (Yes at Step S207), the name identification process 203 proceeds to Step S204 in order to extract the remaining name identification target record.

In contrast, if it is determined that a name identification target record does not remain in a group (No at Step S207), the name identification process 203 performs the judgment using a threshold and outputs the results (Step S208). The flow of the determining process performed on the comprehensive evaluation values using the threshold is the same as that illustrated in FIG. 19; therefore, a description thereof will be omitted here.

Subsequently, the name identification process 203 determines whether a name identification source record remaining in a group (Step S209). If it is determined that a name identification source record remains in a group (Yes at Step S209), the name identification process 203 proceeds to Step S203 in order to extract the remaining name identification source record.

In contrast, if it is determined that a name identification source record does not remain in a group (No at Step S209), the name identification process 203 determines whether a remaining group remains in the multiple groups that are obtained as the results of the grouping by windows (Step S210). If it is determined that a remaining group remains in the groups (Yes at Step S210), the name identification process 203 proceeds to Step S202 in order to the remaining group. In contrast, if it is determined that a remaining group does not remain in the groups (No at Step S210), the name identification process 203 ends the matching performed using the grouping window technique.

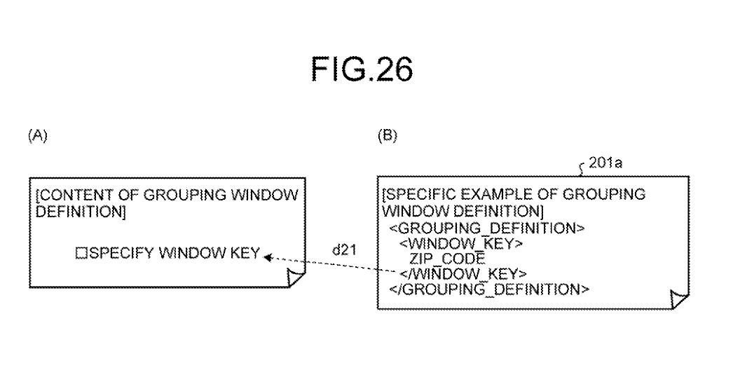

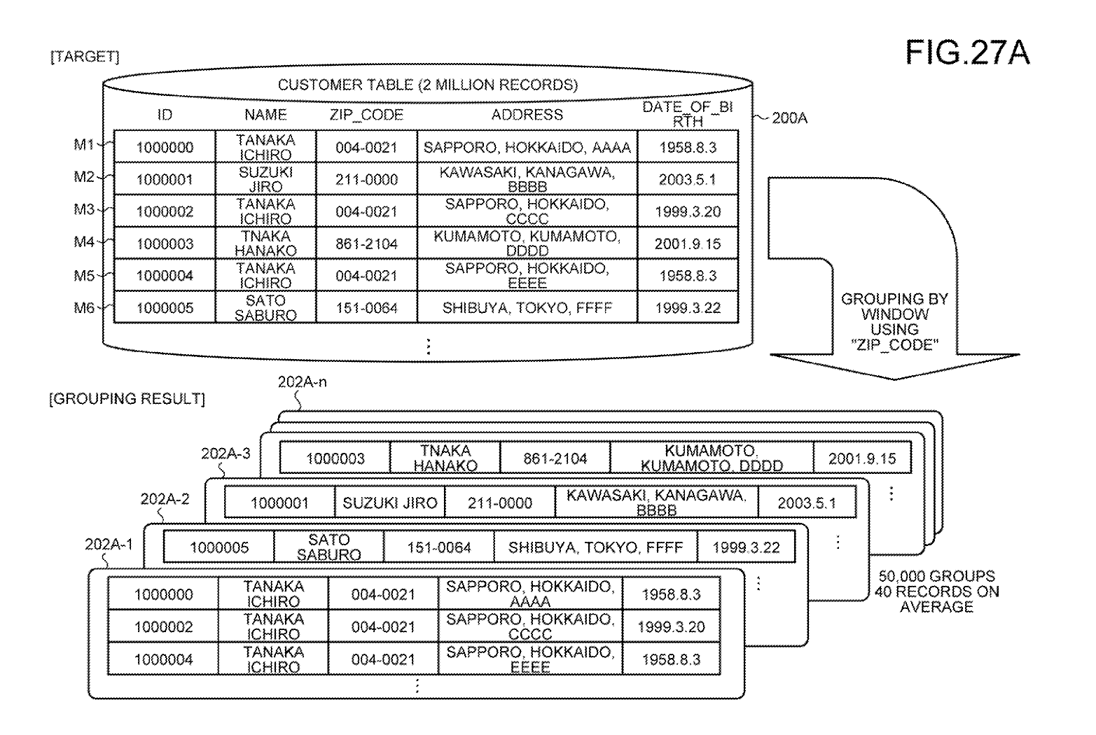

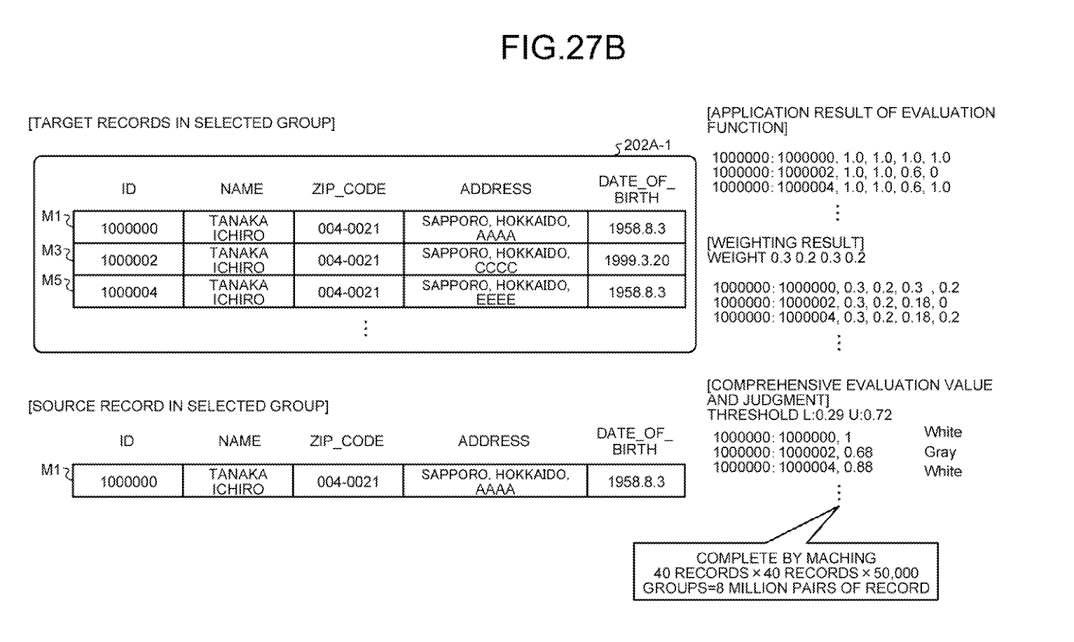

In the following, a specific example of the name identification process using the grouping window will be described with reference to FIGS. 26 and 27. FIG. 26 illustrates an example of the data structure of the grouping window definition. FIG. 26(A) illustrated the content of a grouping window definition. FIG. 26(B) illustrates a specific example of the grouping window definition. FIG. 27 illustrates a specific example of the matching using the grouping window technique. FIG. 27A is a schematic diagram illustrating a specific example of the grouping window technique. FIG. 27B is a schematic diagram illustrating a specific example of the matching performed after grouping windows.

As illustrated in FIG. 26(A), the grouping definition 201a stores, as a window key, an item (an item and a location of the associated data are specified when a part of item data is used) that is used in the process of the grouping window. Specifically, the grouping definition 201a defines that a process of the grouping window is performed using a value of an item specified by a window key. In the example illustrated in FIG. 26(B), a zip code is defined as a window key d21 in the grouping definition 201a.

As illustrated in FIG. 27A, the grouping process 201 uses a customer table 200A as the target and performs the grouping window on the records in the customer table 200A using values of zip codes functioning as a window key. In this case, because the grouping process 201 divides groups using values of the zip codes as a window key, the grouping process 201 creates, for each same zip code, 50,000 groups 202A-1 to n for the records stored in the customer table 200A. Then, the number of average records in each group is 40. In practice, on the order of 100,000 zip codes are present; however, in this case, it is assumed that the zip codes stored in the customer table 200A are 50,000. After the grouping process 201 performs the grouping window, the name identification process 203 performs the matching for each group divided by the grouping window.

FIG. 27B illustrates, as a part of the name identification process after performing the grouping window, an intermediate step of the name identification process performed on the group 202A-1 in which the zip code is “004-0021”. The name identification process 203 uses the records in the group 202A-1 as the name identification source records and the name identification target records and performs the matching the name identification source record with the name identification target record. For example, the name identification process 203 outputs the results by associating, for each combination of the name identification source record M1 and each of the name identification target records M1, M3, and M5 . . . , application results of evaluation functions, weighting results, and comprehensive evaluation values. Then, after the checking, the name identification process 203 performs the judgment on the matching for each combination of the name identification source record M1 and each of the name identification target records M1, M3, and M5 . . . and outputs the judgment result.

As described above, in the name identification process using the grouping window, if 50,000 divided groups are present, the number of records in a single group are an average of 40; therefore, 40 records×40 records×50,000 groups=80 million combinations of records are needed to be checked. Accordingly, in the name identification process using the grouping window in the example illustrated in FIG. 27, the number of checking performed on the records corresponding to the target is about 1/50,000 when compared with a case in which the checking is performed on all of the records (4 trillion combinations) in a round robin manner, thus speeding up the checking related to the matching.

However, the checking related to the matching may not be performed at high speed even when using a technology for speeding up the large-scale matching described above. For example, in the matching using the “rough narrow down”, if many records similar to the name identification source record are present in the name identification target, the number of results 102b obtained from the rough narrow down increases; therefore, an effect of reducing the combinations used for the checking of the name identification source record decreases. Accordingly, in some cases, the name identification process 103 using the rough narrow down may not speed up the checking related to the matching.

Furthermore, because the matching using the “grouping window” is a technique that is used only for the self name identification, when performing the different party name identification in which items stored in records in the name identification source is different from that stored in the name identification target, the “grouping window” is not used. Accordingly, because the grouping process 201 is not used in this case, the checking related to the matching is not performed at high speed.

Furthermore, in the matching using the “grouping window”, if the number of NULL values in which no information is contained in a value of an item (window key) that is used for the grouping window is large, the following problems occur. In the grouping process 201, because the number of records, in a group, having a NULL value as a window key value is large and the name identification process 203 is performed in a round-robin manner on a large number of records, the effect of reducing the combinations used for the checking decreases. Furthermore, because the name identification process 203 does not match groups that have different window keys, the matching is not performed on a record having a value of a window key and on a record having a NULL value. However, the matching is needed when a specific value is supposed to be used for a NULL value. Accordingly, in such a case, the name identification process 203 needs to additionally perform the checking process, in a round-robin manner, on a group having a NULL value and on all of the groups. Therefore, the effect of reducing the combinations used for the checking using the grouping window decreases, and thus the checking related to the matching is not performed at high speed.

Furthermore, in the matching using the “grouping window”, if the number of divided groups is less than a predetermined number, the effect of reducing the combinations for the checking decreases, and thus the checking related to the matching is not performed at high speed. For example, in FIG. 27A, when using, instead of a value of a zip code, the first three digits of a zip code as a window key, the number of groups divided by the grouping of windows is reduced from 50,000 to about 200. Consequently, the number of average records in each group is 10,000, and thus the checking of 10,000 records×10,000 records×200 groups=200,000 million combinations of record is needed. If the number of divided groups is 50,000, the checking of 80 million combinations of records is needed. Accordingly, if the number of divided groups is 200, the combinations used for the checking is significantly increases.

Furthermore, in the matching using the “grouping window”, if values of items (window keys) used for the grouping window vary, the number of records are not constant depending on groups. This decreases the effect of reducing the combinations of the checking and thus the effect of groups containing many records becomes large; therefore, the speeding up of the checking related to the matching is not implemented. For example, in FIG. 27A, if 100,000 customers having the same zip code are present in a group, the checking of 100,000 records×100,000 records=100,000 million combinations of records is needed for only this group. If the number of average records in each group is 40, 80 million combinations of records in total need to be checked. Accordingly, even when checking only one group, if the group has 100,000 records, the number of combinations to be checked is significantly increases.

Configuration of an Information Matching Apparatus According to an Embodiment

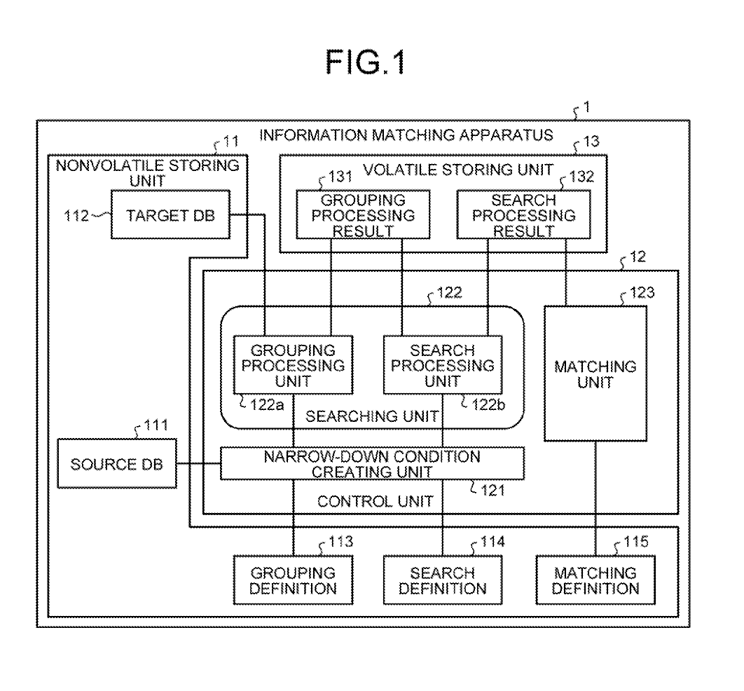

FIG. 1 is a functional block diagram illustrating the configuration of an information matching apparatus according to an embodiment. An information matching apparatus 1 checks records stored in a set of values associated with items and judges the identity, the similarity, and the relationship between the records. As illustrated in FIG. 1, the information matching apparatus 1 includes a nonvolatile storing unit 11, a control unit 12, and a volatile storing unit 13. The nonvolatile storing unit 11 is a storage area that does not lose data stored therein even when electrical power is not supplied from, for example, an AC power supply or a battery. Furthermore, the nonvolatile storing unit 11 includes a source DB 111, a target DB 112, a grouping definition 113, a search definition 114, and a matching definition 115. The nonvolatile storing unit 11 is a semiconductor memory device, such as a flash memory, or a storing unit, such as a hard disk or an optical disk.

The source DB 111 is a database (DB) that stores therein a plurality of records (name identification source records) to be matched. The target DB 112 is a DB that stores therein a plurality of records (name identification target records) that is the other party of the matching. In the embodiment, a description will be given with the assumption that a large number of records are stored in the target DB 112. For items in the source DB 111 and the target DB 112, items may be completely match, items may be partially match, part of items may have relationship with each other even when items do not completely match. Furthermore, the source DB 111 and the target DB 112 may be databases that have the same information or they may also be a single database. Furthermore, the source DB 111 does not need to be a DB. For example, the source DB 111 may be an XML, a CSV file, or the like as long as it has a function of sequentially extracting records. Similarly, the target DB 112 does not need to be a DB. For example, the target DB 112 may be an XML, a CSV file, or the like as long as it has a function of sequentially extracting records and a search function using items. The grouping definition 113, the search definition 114, and the matching definition 115 will be described later.

When matching the name identification source records, the control unit 12 performs, on name identification target records stored in the target DB 112, a two-step narrow-down process for narrowing down the name identification target records in two steps. Furthermore, the control unit 12 includes a narrow-down condition creating unit 121, a searching unit 122, and a matching unit 123. The control unit 12 is an integrated circuit, such as an application specific integrated circuit (ASIC) or field programmable gate array (FPGA), or an electronic circuit, such as a central processing unit (CPU) or a micro processing unit (MPU).

The volatile storing unit 13 is a storage area that loses data stored therein when electrical power is not supplied from, for example, an AC power supply or a battery. Furthermore, the volatile storing unit 13 includes a grouping processing result 131 and a search processing result 132. The volatile storing unit 13 is a storing unit that includes a semiconductor memory device, such as a random access memory (RAM) or a dynamic random access memory (DRAM).

For values of name identification items included in the name identification source records, the narrow-down condition creating unit 121 combines, using a logical multiplication (AND), a search condition defined by the search definition 114 and a grouping condition defined by the grouping definition 113 and creates a narrow-down condition that is used to narrow down records stored in the name identification target. The grouping definition 113 mentioned here is a file in which a condition for limiting an area (matching area) of the target DB 112 to be matched. In other words, the grouping definition 113 is a definition used to divide the name identification target records stored in the target DB 112 into an area in which the matching is performed and an area in which the matching is not performed. Furthermore, for values of the name identification items contained in the name identification source records, the search definition 114 is a file in which a condition for excluding candidates, in the name identification target records, that are less likely to be similar to or related with values of the name identification items contained in the name identification source records is defined.

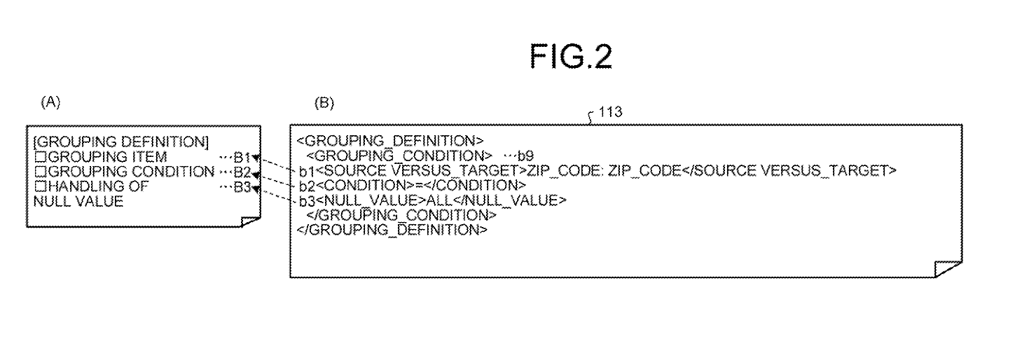

An example of the grouping definition 113 will be described with reference to FIG. 2. FIG. 2 is a schematic diagram illustrating an example of the data structure of a grouping definition. FIG. 2(A) illustrates the content of the grouping definition 113. FIG. 2(B) illustrates a specific example of the grouping definition 113. As illustrated in FIG. 2(A), the grouping definition 113 stores therein, in an associated manner, a grouping item B1, a grouping condition B2, and a handling of NULL value B3. The grouping item B1 indicates a key item for grouping the name identification target. In the grouping item B1, items in a name identification source record associated with items in a name identification target record are set as a pair. The grouping condition B2 indicates a condition for grouping name identification target records stored in the target DB 112 by using items indicated by the grouping item B1 and values of the corresponding items. The handling of NULL value B3 indicates whether a record in which a NULL value is set to a grouping item value is to be searched that is subsequently performed.

As illustrated in FIG. 2(B), the grouping definition 113 stores therein, as a grouping condition b9, a “source versus target” b1, a “condition” b2, and a “NULL value” b3. The “source versus target” b1 is associated with the grouping item B1 and describes the “name identification source item:name identification target item”. The “condition” b2 is associated with the grouping condition B2. The “NULL value” b3 is associated with the handling of NULL value B3. For example, in the “source versus target” b1, grouping items for the name identification source record and the name identification target record are set, in which a zip code is used as an item stored in the name identification source record and a zip code is used as an item contained in the name identification target record. In the “condition” b2, “=” is set as a grouping condition. In the “NULL value” b3, “ALL” is set that indicates all of the records in which a NULL value is set to a grouping item value are to be searched at a subsequent process. Accordingly, a grouping condition created by the grouping definition 113 illustrated in FIG. 2(B) is the “zip code=a value of a zip code stored in a name identification source record OR zip code=NULL”.‘OR’ is a logical addition. In the example illustrated in FIG. 2(B), a case in which a single grouping condition b9 is used is described; however, a plurality of grouping conditions b9 may also be used.

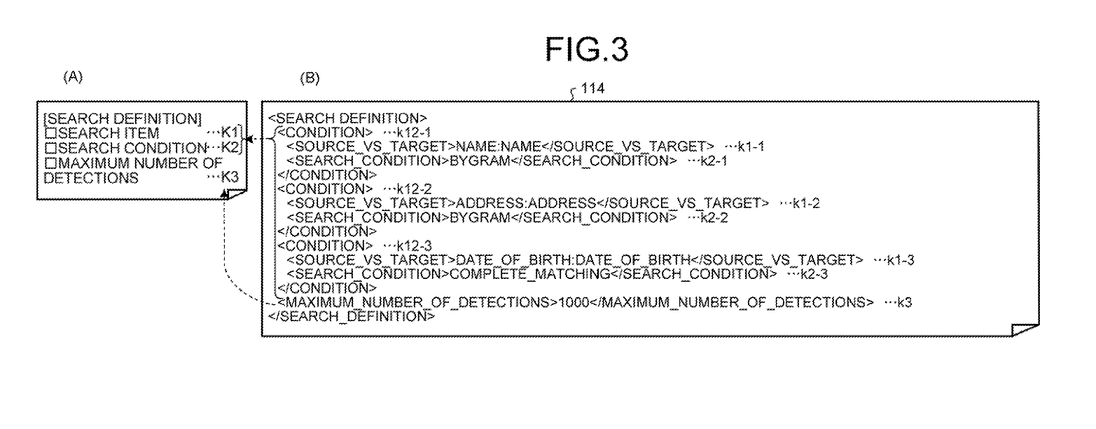

In the following, an example of the search definition 114 will be described with reference to FIG. 3. FIG. 3 is a schematic diagram illustrating an example of the data structure of the search definition. FIG. 3(A) illustrates the content of the search definition 114. FIG. 3(B) illustrates a specific example of the search definition 114. As illustrated in FIG. 3(A), the search definition 114 stores therein, in an associated manner, a search item K1 and a search condition K2 and also stores, as needed, the maximum number of detections K3. The search item K1 indicates a key item for roughly narrowing down the name identification target. In the search item K1, for the name identification source record and the name identification target record, items associated with the name identification source record and the name identification target record are set. The search condition K2 indicates a condition for searching the target DB 112 by using an item indicated by the search item K1 and by using a value of the associated item. The search condition K2 includes, for example, “BYGRAM” that is used to search for values indicating the matching of consecutive two characters or “complete matching” that is used to search for values that completely match. The maximum number of detections K3 indicates the maximum number of records of the search results obtained by searching for a single name identification source record. No limit is placed, if the maximum number of detections K3 is not present.

As illustrated in FIG. 3(B), the search definition 114 associates “source vs target” k1-1 to 3 with search conditions k2-1 to 3 to produce search conditions k12-1 to 3 and stores therein the search conditions k12-1 to 3 and the maximum number of detections k3. The “source vs target” k1-1 to 3 are associated with the search item K1. The “search conditions” k2-1 to 3 are associated with the search condition K2. The maximum number of detections k3 is associated with the maximum number of detections K3. For example, in the “source vs target” k1-1, search items for the name identification source record and the name identification target record are set, in which a name is used as an item stored in a name identification source record and a name is used as an item stored in a name identification target record. The “BYGRAM” is set in the “search condition” k2-1. In the “source vs target” k1-3, search items for the name identification source record and the name identification target record are set, in which a date of birth is used as an item stored in the name identification source record and a date of birth is used as an item contained in the name identification target record. The “complete matching” is set in the “search condition” k2-3. Accordingly, the search condition created by the search definition 114 illustrated in FIG. 3(B) is the “BYGRAM(name=a value of a name of a name identification source record) OR BYGRAM (address=a value of an address of a name identification source record) OR complete matching (date of birth=a value of a date of birth of a name identification source record)”. Furthermore, the maximum number of records obtained when a search condition created for a single record in the name identification source is used is defined to be 1000 records as the maximum number of detections k3.

Referring back to FIG. 1, the narrow-down condition creating unit 121 sequentially obtains the grouping conditions b9 defined by the grouping definition 113. Furthermore, the narrow-down condition creating unit 121 creates a grouping condition from an item of the “source versus target” b1 contained in the obtained grouping condition b9, the “condition” b2, and a value of the corresponding item in a name identification source record. Furthermore, if the NULL value b3 contained in the obtained grouping condition b9 is indicated to be searched that will be subsequently performed, the narrow-down condition creating unit 121 combines, using OR, the grouping condition and a condition for validating the NULL value as a value of an item for the “source versus target” b1. Then, if a plurality of grouping conditions b9 is present, the narrow-down condition creating unit 121 combines, using AND, the grouping conditions created from the grouping conditions b9.

Furthermore, if the narrow-down condition creating unit 121 sequentially obtains the search conditions k12 defined by the search definition 114. Furthermore, the narrow-down condition creating unit 121 creates a search condition from an item of the “source vs target” k1 contained in the obtained search condition k12, the “search condition” k2, and a value of the corresponding item in a name identification source record. Then, if a plurality of search conditions k12 is present, the narrow-down condition creating unit 121 combines, using OR, the search conditions created from each of the search conditions k12. Furthermore, the narrow-down condition creating unit 121 combines, using AND, the created grouping condition and the created search condition and creates a narrow-down condition for narrowing down records in the name identification target.

In accordance with the narrow-down condition created by the narrow-down condition creating unit 121, the searching unit 122 searches the target DB 112 for a record to be matched. Furthermore, the searching unit 122 includes a grouping processing unit 122a and a search processing unit 122b.

The grouping processing unit 122a searches the target DB 112 for a record that matches the grouping condition contained in the narrow-down condition created by the narrow-down condition creating unit 121. Specifically, the grouping processing unit 122a splits the name identification target in the target DB 112 into an area in which the matching is performed and an area in which the matching is not performed. Then, the grouping processing unit 122a stores the searched record in the grouping processing result 131. The record stored in the grouping processing result 131 is to be searched by the search processing unit 122b, which will be subsequently performed. Furthermore, by using an index previously constructed for the name identification item in the target DB 112, the grouping processing unit 122a may divide the name identification target in the target DB 112 into an area in which the matching is performed and an area in which the matching is not performed.

The search processing unit 122b searches the grouping processing result 131 for a record that matches the search condition contained in the narrow-down condition created by the narrow-down condition creating unit 121. Specifically, from among the records stored in the grouping processing result 131, the search processing unit 122b excludes candidates less likely to be matched. Then, the search processing unit 122b stores the searched record in the search processing result 132. The record stored in the search processing result 132 is to be matched later by the matching unit 123.

Processes performed by the grouping processing unit 122a and the search processing unit 122b are logical functions and do not need to be performed in two stages. Specifically, by searching the target DB 112 using all of the narrow-down conditions created by the narrow-down condition creating unit 121, the searching unit 122 can be configured such that it directly outputs the search processing result 132 without creating the grouping processing result 131. Furthermore, an index of the search item and the grouping item may also be used when the searching unit 122 searches the target DB 112.

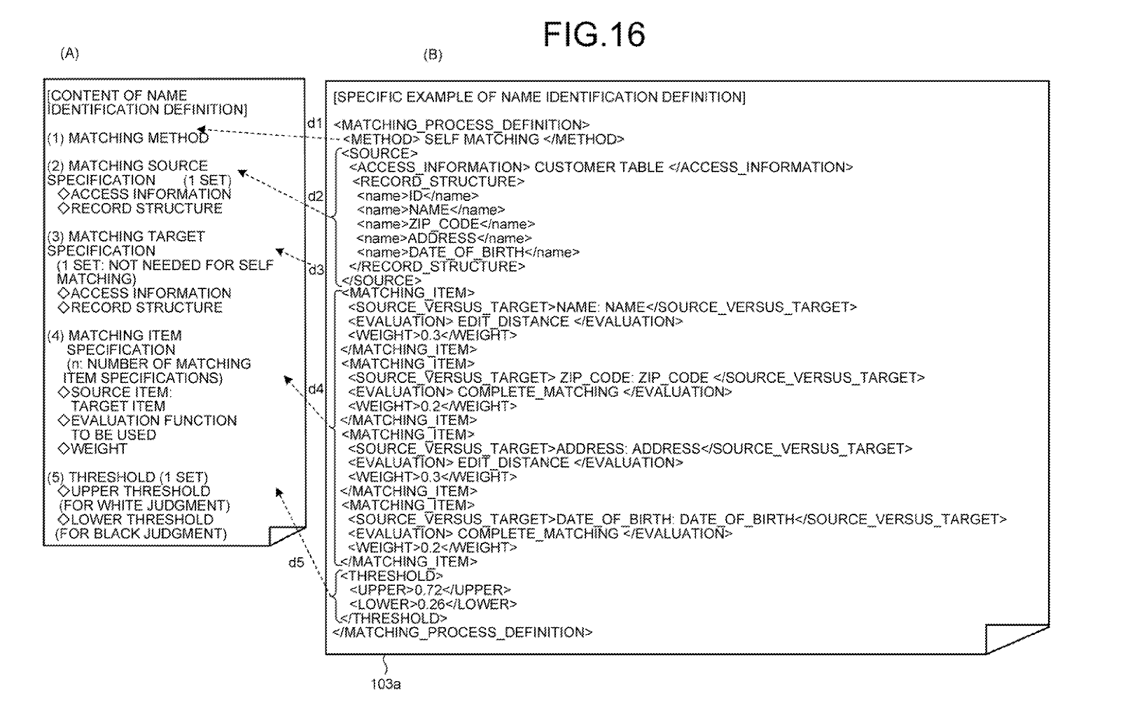

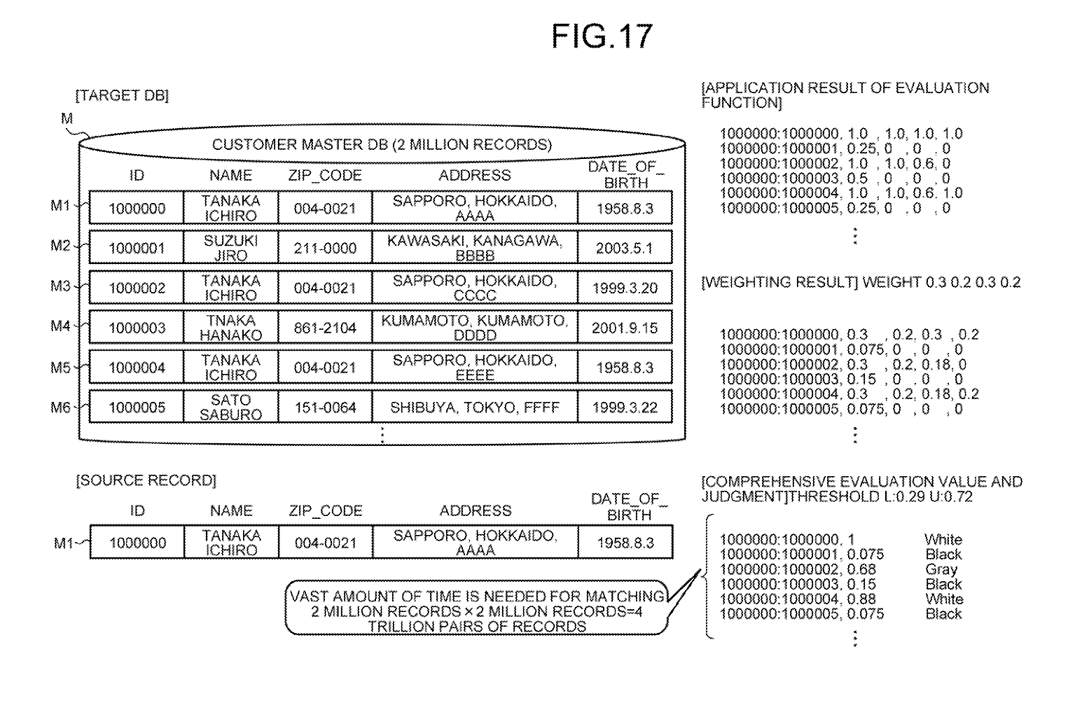

The matching unit 123 performs a matching, in accordance with the matching definition 115, the name identification source records by using the search processing result 132 as the name identification target. In the matching definition 115, a name identification item, an evaluation function and the weight that are used for each name identification item, and a threshold for judging a result are defined. A higher threshold for judging “White” and a lower threshold for judging “Black” are defined for the threshold. The data structure of the matching definition 115 is the same as that illustrated in FIG. 16; therefore, a description thereof will be omitted here. Specifically, the matching unit 123 sequentially obtains name identification target records from the name identification target records stored in the search processing result 132. Furthermore, for a value of each name identification item contained in the obtained name identification target records and a name identification source record, the matching unit 123 performs the checking using an evaluation function prescribed for each name identification item. Furthermore, after checking, the matching unit 123 weights, for each name identification item, an evaluation value of each name identification item, adds the obtained each value, and derives a comprehensive evaluation value. Furthermore, for the remaining name identification target records, similarly, the matching unit 123 derives comprehensive evaluation values for combinations of the name identification source records and the name identification target records. Furthermore, the matching unit 123 creates a matching candidate set containing a comprehensive evaluation value of combinations of the name identification source records and the name identification target record. Furthermore, in accordance with the threshold previously defined in the matching definition 115, the matching unit 123 performs the determination related to the matching for combinations of records belonging to the matching candidate set. At this time, a determination result may be output by performing determining process using a threshold immediately after deriving a comprehensive evaluation value. In such a case, the matching candidate set that contains the comprehensive evaluation value does not need to be kept.

Flow of an Overall Name Identification Process

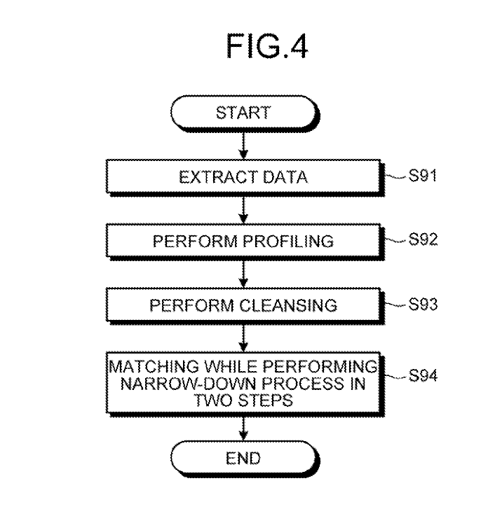

The flow of an overall name identification process performed by the information matching apparatus 1 will be described with reference to FIG. 4. FIG. 4 is a flowchart illustrating the flow of an overall name identification process. First, the control unit 12 sequentially extracts data on items stored in the records from the name identification source DB 111, corresponding to the marging target, and the target DB 112 (Step S91). Then, the control unit 12 performs profiling in which the property of the extracted data is analyzed (Step S92). Consequently, a matching method including the determination of items for the matching is determined in accordance with the profiling performed by a person and then a matching tool is set in accordance with the determined matching method. Then, in accordance with the set matching tool, the control unit 12 performs a cleansing process for formatting the extracted data such that the data is easily to be matched (Step S93). Thereafter, for each record stored in the source DB 111, the control unit 12 performs the matching while performing a two-step narrow-down process for narrowing down, in two steps, name identification target records in the target DB 112 and outputs the matching results (Step S94). Then, a person performs the verification or approval of the validity of the matching results and performs a needed process for, for example, reflecting the matching result with respect to the target DB 112. Because the present invention is related to the name identification process (Step s94), in the embodiment, the name identification process (Step s94) is mainly described.

Flow of the Two-Step Narrow-Down Process According to the Embodiment

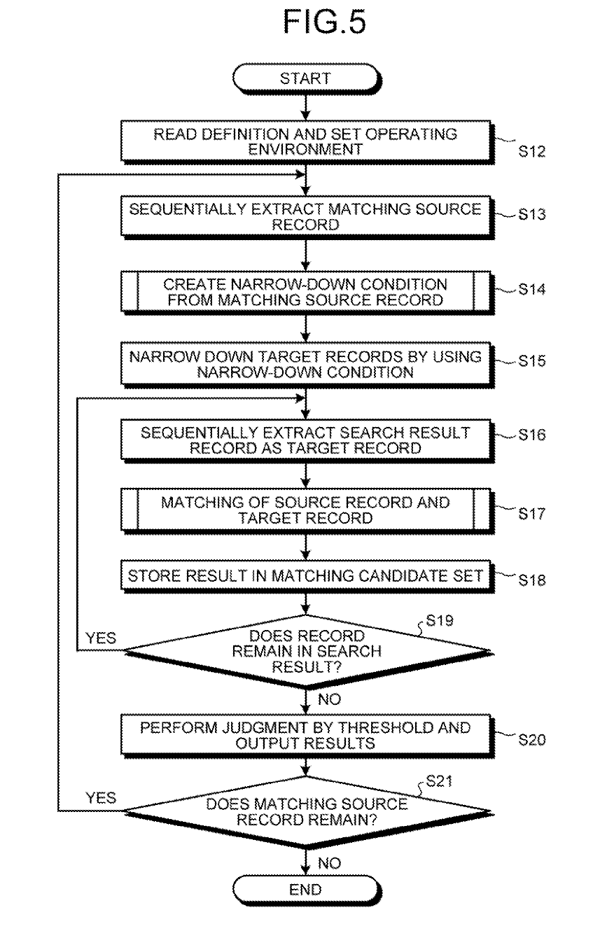

In the following, the flow of the two-step narrow-down process according to the embodiment will be described with reference to FIG. 5. FIG. 5 is a flowchart illustrating the flow of a two-step narrow-down process performed in the name identification process according to the embodiment.

When receiving an instruction to perform the matching, first, the control unit 12 reads the grouping definition 113, the search definition 114, and the matching definition 115 and sets an operating environment (Step S12). Then, the control unit 12 sequentially extracts, from the name identification source DB 111, a name identification source records to be matched (Step S13).

Subsequently, the narrow-down condition creating unit 121 creates a narrow-down condition from the extracted name identification source record (Step S14). Then, by using the narrow-down condition created by the target DB 112, the searching unit 122 narrows down the name identification target records in the target DB 112 (Step S15). Specifically, the grouping processing unit 122a searches the target DB 112 for records that match the grouping condition contained in the narrow-down condition that is created by the narrow-down condition creating unit 121 and stores the searched records in the grouping processing result 131. Then, the search processing unit 122b searches the grouping processing result 131 for records that match the search condition contained in the narrow-down condition created by the narrow-down condition creating unit 121 and stores the searched records in the search processing result 132.

The process for narrowing down the name identification target records (Step S15) does not need to be performed in two steps. Specifically, by searching the target DB 112 using all of the narrow-down conditions created by the narrow-down condition creating unit 121, the searching unit 122 may also directly output the search processing result 132 without creating the grouping processing result 131. Furthermore, an index of the search item and the grouping item may also be used when the searching unit 122 searches the target DB 112.

Subsequently, the matching unit 123 sequentially extracts each record stored in the search processing result 132 as a name identification target record (Step S16) and performs the matching (checking process) of the name identification source records and the name identification target records (Step S17). The flow of the checking process is the same as that illustrated in FIG. 20; therefore, a description thereof will be omitted here. Then, the matching unit 123 stores the check results in the matching candidate set (Step S18). Comprehensive evaluation values are included in the check results.

Then, the matching unit 123 determines whether a record remains in the search processing result 132 (Step S19). If it is determined that a record remains in the search processing result 132 (Yes at Step S19), the matching unit 123 proceeds to Step S16 in order to extract the remaining record.

In contrast, if it is determined that a record does not remain in the search processing result 132 (No at Step S19), the matching unit 123 performs the determination on the comprehensive evaluation value stored in the matching candidate set using a threshold and outputs a determination result (Step S20). The process for performing the determination on the comprehensive evaluation value using the threshold and outputting the determination result (Step S20) may also be performed immediately after the checking process (Step S17) for checking a name identification source record against a name identification target record. In such a case, there is no need to perform a process for storing the records in the matching candidate set (Step S18).

Then, the control unit 12 determines whether a name identification source record remains in the source DB 111 (Step S21). If it is determined that a name identification source record remains in the source DB 111 (Yes at Step S21), the control unit 12 proceeds to Step S13 in order to extract the remaining name identification source record. In contrast, if it is determined that a name identification source record does not remain in the name identification source DB 111 (No at Step S21), the control unit 12 ends the matching using the two-step narrow-down process.

Flow of the Narrow-Down Condition Creating Process According to the Embodiment

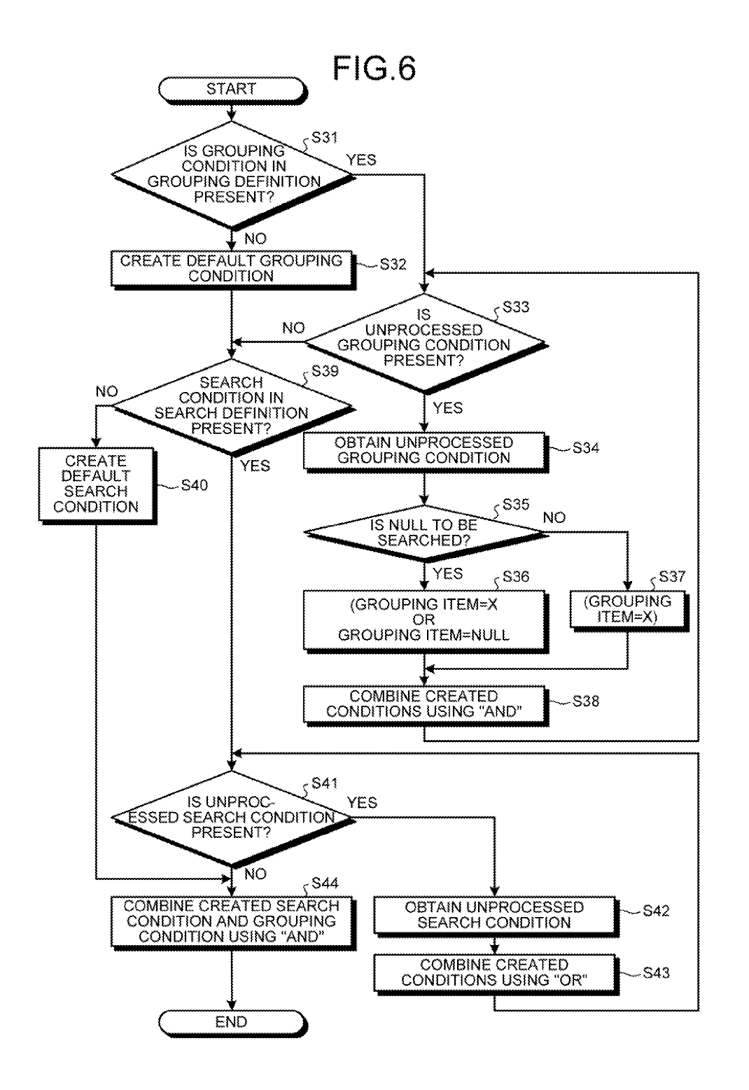

In the following, the flow of the process performed at S14 illustrated in FIG. 5 will be described with reference to FIG. 6. FIG. 6 is a flowchart illustrating the flow of a narrow-down condition creating process according to the embodiment.

First, the narrow-down condition creating unit 121 determines whether a grouping condition b9 is stored in the grouping definition 113 (Step S31). If it is determined that the grouping condition b9 is not stored in the grouping definition 113 (No at Step S31), the narrow-down condition creating unit 121 creates a default grouping condition (Step S32). In the default grouping condition, “TRUE” is set as a non-grouping condition. Then, the narrow-down condition creating unit 121 proceeds to Step S39 in order to create a search condition.

In contrast, if it is determined that the grouping condition b9 is stored in the grouping definition 113 (Yes at Step S31), the narrow-down condition creating unit 121 determines whether an unprocessed grouping condition b9 is stored in the grouping definition 113 (Step S33). If it is determined that an unprocessed grouping condition b9 is not stored in the grouping definition 113 (No at Step S33), the narrow-down condition creating unit 121 proceeds to Step S39 in order to create a search condition.

In contrast, if it is determined that an unprocessed grouping condition b9 is stored in the grouping definition 113 (Yes at Step S33), the narrow-down condition creating unit 121 obtains the unprocessed grouping condition b9 from the grouping definition 113 (Step S34). Then, in accordance with the NULL value b3 stored in the obtained grouping condition b9, the narrow-down condition creating unit 121 determines whether the NULL value is to be searched at the subsequent process (Step S35). If it is determined that the NULL value is to be searched at the subsequent process (Yes at Step S35), the narrow-down condition creating unit 121 creates the “grouping item=X OR grouping item=NULL” as a condition (Step S36). In contrast, if it is determined that the NULL value is not to be searched at the subsequent process (No at Step S35), the narrow-down condition creating unit 121 creates the “grouping item=X” as a condition (Step S37). The “grouping item” mentioned here indicates an item name stored in a name identification target obtained from the “name identification source item name:name identification target item name” specified by the “source versus target” b1. The “X” mentioned here indicates a value of the name identification source item specified by the “source versus target” b1 in the name identification source record. The “=” mentioned here is specified by the “condition” b2.

Then, the narrow-down condition creating unit 121 combines, using AND, the created condition and the condition created by the processed grouping condition b9 (Step S38). Then, the narrow-down condition creating unit 121 proceeds to Step S33.

If all of the grouping conditions b9 have been processed (No at Step S33), the narrow-down condition creating unit 121 determines whether a search condition k12 is present in the search definition 114 (Step S39). If it is determined that the search condition k12 is not present in the search definition 114 (No at Step S39), the narrow-down condition creating unit 121 creates a default search condition (Step S40). In the default search condition, “*” is set as a condition for unconditionally keeping the previous condition. Then, the narrow-down condition creating unit 121 proceeds to Step S44 in order to create a narrow-down condition.

In contrast, if it is determined that a search condition k12 is stored in the search definition 114 (Yes at Step S39), the narrow-down condition creating unit 121 determines whether an unprocessed search condition k12 is stored in the search definition 114 (Step S41). If it is determined that an unprocessed search condition k12 is not stored in the search definition 114 (No at Step S41), the narrow-down condition creating unit 121 proceeds to Step S44 in order to create a narrow-down condition.

In contrast, if it is determined that an unprocessed search condition k12 is stored in the search definition 114 (Yes at Step S41), the narrow-down condition creating unit 121 obtains the unprocessed search condition k12 from the search definition 114 (Step S42). Then, the narrow-down condition creating unit 121 creates a search condition from search items, from search conditions, and from values of the search items in the name identification source records. The search condition created at this stage is the “search condition (search item=X)”. The “search item” mentioned here indicates an item name stored in the name identification target obtained from the “name identification source item name:name identification target item name” specified by the “source vs target” k1. The “X” mentioned here indicates a value of the name identification source item specified by the “source vs target” k1 in the name identification source record. The “search condition” mentioned here indicates a search method represented by the search condition k2. The narrow-down condition creating unit 121 combines, using OR, the created condition and the condition created by the processed search condition k12 (Step S43). Then, the narrow-down condition creating unit 121 proceeds to Step S41.

If the search condition creating process has been performed on all of the search conditions k12 (No at Step S41), the narrow-down condition creating unit 121 combines, using AND, the created search condition and the previously created grouping condition (Step S44) and creates a narrow-down condition.

Operation for Creating the Narrow-Down Condition According to the Embodiment

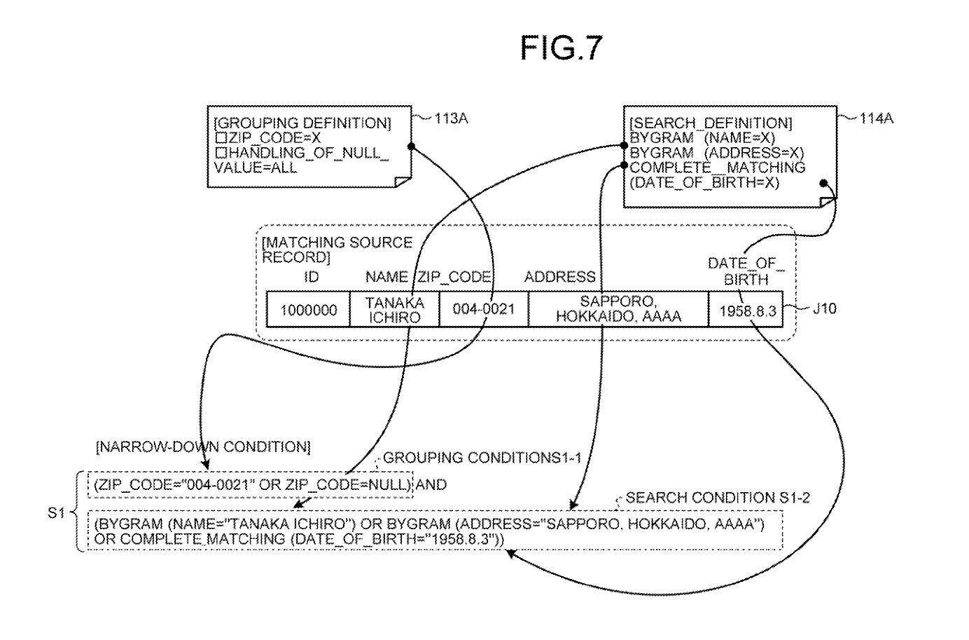

In the following, an operation for creating the narrow-down condition according to the embodiment will be described with reference to FIG. 7. FIG. 7 is a schematic diagram illustrating an example of an operation for creating a narrow-down condition according to the embodiment. As illustrated in FIG. 7, in accordance with a grouping definition 113A and a search definition 114A, a narrow-down condition S1 is created for a matching source record J10. In the grouping definition 113A, it is assumed that a condition, in which the grouping item B1 is the “zip code:zip code” and the grouping condition B2 is “=”, is defined and assumed that a condition (grouping condition b9) in which the handling of NULL value B3 is “ALL” (a NULL value to be searched at the subsequent process) is defined. In the search definition 114A, a first search condition, a second search condition, and a third search condition are defined. It is assumed that the first search condition mentioned here is a condition in which the search item k1-1 is the “name:name” and the search condition k2-1 is the “BYGRAM”. It is assumed that the second search condition mentioned here is a condition in which a saerch item k1-2 is the “address:address” and a search condition k2-2 is the “BYGRAM”. It is assumed that the third search condition mentioned here is a condition in which the search item k1-3 is the “date of birth:date of birth” and the search condition k2-3 is the “complete matching”. Both of the matching source record J10 and the target DB 112 include items of an ID, a name, a zip code, an address, and a date of birth.

First, the narrow-down condition creating unit 121 obtains an unprocessed grouping condition b9 from the grouping definition 113A; obtains, from the name identification source record J10, “004-0021”, i.e., a value of a “zip code” of the name identification source item contained in the “zip code:zip code” that specifies the “grouping item” B1 in the obtained grouping condition b9; and obtains a “zip code” as a name identification target item name. Furthermore, the narrow-down condition creating unit 121 obtains the “=” from the “condition” B2 in the obtained grouping condition b9. Furthermore, in accordance with the “ALL” indicating the handling of NULL value B3 in the obtained grouping condition b9, the narrow-down condition creating unit 121 determines that a zip code containing the NULL value is to be searched at the subsequent process. Then, the narrow-down condition creating unit 121 creates the “zip code=004-00210R zip code=NULL” as the grouping condition S1-1.

Then, the narrow-down condition creating unit 121 obtains an unprocessed first search condition from the search definition 114A; obtains, from the search item K1 in the obtained first search condition, an item name “name” stored in the name identification source and an item name “name” stored in the name identification target; and creates a first condition from values of corresponding search items in the search condition K2 and the name identification source record J10. Here, the narrow-down condition creating unit 121 creates the “BYGRAM(name=“Tanaka Ichiro”)” as the first condition. Furthermore, the narrow-down condition creating unit 121 creates a second condition from values of corresponding search items in the second search condition and the name identification source record J10. Here, the narrow-down condition creating unit 121 creates the “BYGRAM(address=“Sapporo, Hokkaido, AAAA”)” as the second condition. Then, the narrow-down condition creating unit 121 creates a search condition by combining, using OR, the second condition and the first condition that has already been processed.

Furthermore, the narrow-down condition creating unit 121 creates a third condition from values of corresponding search items in the third search condition and the name identification source record J10. Here, the narrow-down condition creating unit 121 creates a “complete matching (date of birth=“1958.8.3”)” as the third condition. Then, the narrow-down condition creating unit 121 creates a new search condition S1-2 by combining, using OR, the created third condition and the processed search condition. Then, the narrow-down condition creating unit 121 creates the narrow-down condition S1 by combining, using AND, the created search condition S1-2 and the already created grouping condition S1-1.

In the above description, a case is described in which the narrow-down condition creating unit 121 creates a narrow-down condition from the grouping definition 113A and the search definition 114A every time the narrow-down condition creating unit 121 creates a narrow-down condition for a name identification source record with respect to a name identification target record. However, the narrow-down condition creating unit 121 is not limited thereto. For example, when creating a narrow-down condition with respect to a first name identification source record, a narrow-down condition template may be created from the grouping definition 113A and the search definition 114A. Then, the narrow-down condition creating unit 121 creates, using the created template, a narrow-down condition for the name identification target record with respect to a name identification source record.

Modification of the Narrow-Down Condition Creating Unit

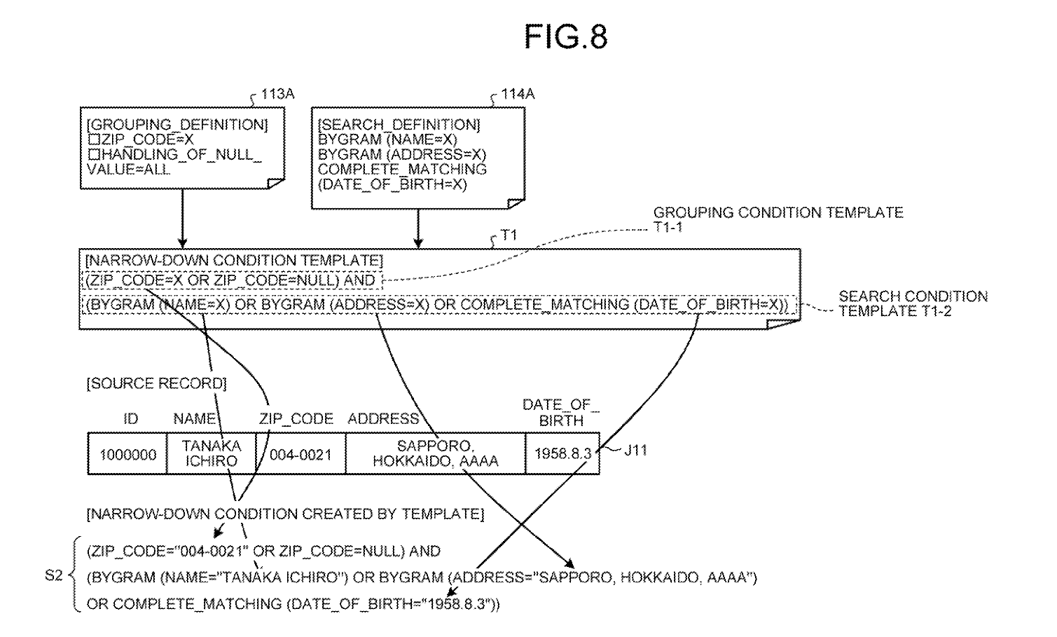

Accordingly, a case will be described with reference to FIG. 8, in which, when creating a narrow-down condition for the name identification target with respect to a first name identification source record, a modification of the narrow-down condition creating unit 121 creates a the narrow-down condition template and creates the narrow-down condition with respect to each name identification source record by using the created template. FIG. 8 is a schematic diagram illustrating an example of an operation for creating the narrow-down condition when a narrow-down condition template according to the embodiment is created.

As illustrated in FIG. 8, by using a the narrow-down condition template created from the grouping definition 113A and the search definition 114A, the narrow-down condition S2 related to the matching source record J11 is created. The content of the grouping definition 113A, the search definition 114A, and the matching source record J11 are the same as those illustrated in FIG. 7; therefore, a description thereof will be omitted here.

First, when creating a narrow-down condition for the name identification target with respect to a first name identification source record, the narrow-down condition creating unit 121 creates a grouping condition template from the grouping definition 113A. In this case, a “zip code=X OR zip code=NULL” is created a grouping condition template T1-1. Here, X is a variable for an item value associated with a target name identification source record. Then, when creating a narrow-down condition with respect to the first name identification source record, the narrow-down condition creating unit 121 creates a search condition template from the search definition 114A. In this case, the “BYGRAM(name=X) OR BYGRAM(address=X) OR complete matching (date of birth=X)” is created as a template T1-2 for the search condition. Here, X is a variable for an item value associated with a target name identification source record. Then, the narrow-down condition creating unit 121 combines, using AND, the created the search condition template T1-2 and the created grouping condition template T1-1 and thus creates a narrow-down condition template T1.

Then, when creating a narrow-down condition for a matching source record J11, the narrow-down condition creating unit 121 embeds, in each of the variables X in the created narrow-down condition template T1, values of the search items and the grouping items stored in the matching source record J11 and thus creates a narrow-down condition S2. In this case, the narrow-down condition creating unit 121 embeds “004-0021” in a variable X for the “zip code” in the narrow-down condition template T1. Furthermore, the narrow-down condition creating unit 121 embeds “Tanaka Ichiro” in a variable X for the “name” in the narrow-down condition template T1. Furthermore, the narrow-down condition creating unit 121 embeds the “Sapporo, Hokkaido, AAAA” in a variable X for the “address” in the narrow-down condition template T1. Furthermore, the narrow-down condition creating unit 121 embeds “1958.8.3” in a variable X for the “date of birth” in the narrow-down condition template T1. Consequently, the narrow-down condition creating unit 121 creates the narrow-down condition S2 for the name identification source record J11.

Modification of the Searching Unit

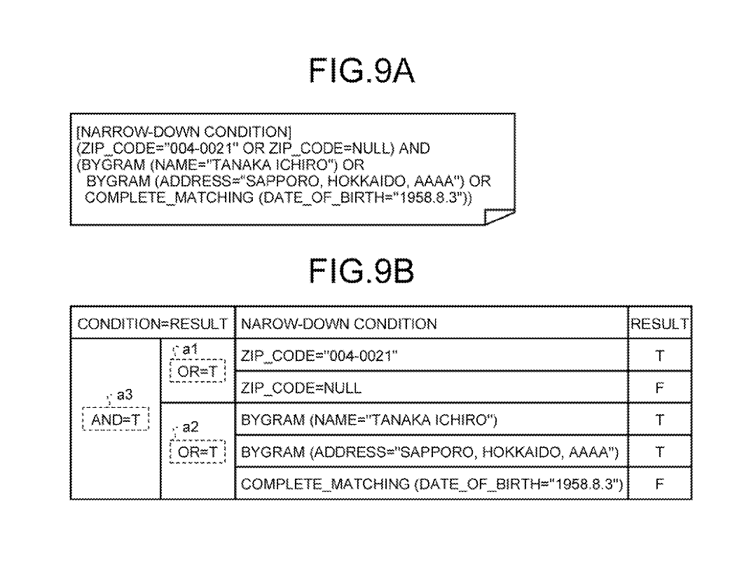

After applying conditions stored in the narrow-down conditions created from the name identification source record to the name identification target records, the searching unit 122 described above searches for a name identification target record satisfying that the logical expression is TRUE. FIGS. 9A and 9B are schematic diagrams illustrating an example of a search according to the embodiment. FIG. 9A indicates a narrow-down condition for a name identification source record. FIG. 9B illustrates an example of a search result obtained when each condition stored in the narrow-down condition is used for a name identification target record.

As illustrated in FIG. 9B, because the “zip code=“004-0021”” is TRUE (abbreviated to “T”), the “zip code=NULL” is FALSE (abbreviated to “F”). Accordingly, the searching unit 122 calculates these using OR to derive “T” (al). Furthermore, because the “BYGRAM(name=“Tanaka Ichiro”)” is “T”, because the “BYGRAM(address=“Sapporo, Hokkaido, AAAA”)” is “T”, and because the “complete matching (date of birth=“1958.8.3”)” is “F”, the searching unit 122 calculates them using OR to derive “T” (a2). Then, the searching unit 122 calculates the two derived “T” using AND to derive “T” (a3). Because the logical expression of the result obtained by using each condition is TRUE, the searching unit 122 extracts this name identification target record as a search result.

In the above, a case has been described in which, after applying conditions stored in the narrow-down conditions created from the name identification source record to the name identification target records, the searching unit 122 searches for name identification target records in which the logical expression is TRUE; however, the searching unit 122 is not limited thereto. For example, in accordance with the degree of matching of each condition contained in the narrow-down condition created from the name identification source record, the searching unit 122 may perform an “ordering search” by scoring name identification target records and extracting, as the search results, the name identification target records in descending order of the scores.

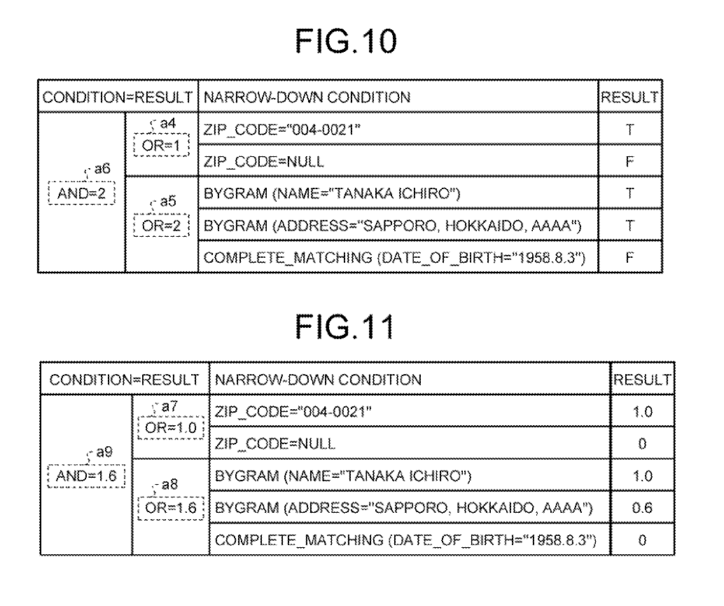

FIG. 10 is a schematic diagram illustrating an example of an ordering search according to the embodiment. As illustrated in FIG. 10, the searching unit 122 scores in accordance with “T” and “F” representing an application result of each condition in the narrow-down conditions, calculates a total score using an OR condition and an AND condition, and gives the total score to a name identification target record that is to be searched. In the example illustrated in FIG. 10, if the logical expression is “T”, the searching unit 122 gives one score, whereas, if the logical expression is “F”, the searching unit 122 gives a zero score. Furthermore, the searching unit 122 adds scores of the application results of the conditions when using the OR condition, whereas the searching unit 122 multiplies scores of the application results of the conditions when using the AND condition. Specifically, because the “zip code=004-0021” is “T” and the “zip code=NULL” is “F”, the searching unit 122 derives “1” (a4) from “1+0” using an OR condition for these search conditions. Furthermore, because the “BYGRAM(name=“Tanaka Ichiro”)” is “T”, because the “BYGRAM(address=“Sapporo, Hokkaido, AAAA”)” is “T”, and because the “complete matching(date of birth=“1958.8.3”)” is “F”, the searching unit 122 derives “2” (a5) from “1+1+0” using OR conditions for these search conditions. Then, the searching unit 122 multiplies the two derived scores using an AND condition to derive the total score “2” (a6). Thereafter, the searching unit 122 sorts the name identification target records in descending order of the total scores and extracts, as the search results, records from the top corresponding to, for example, the maximum number of detections k3 defined by the search definition 114. In the process for sorting the name identification target records in descending order of the total scores, it is, of course, possible to exclude a name identification target record whose total score is zero.

FIG. 11 is a schematic diagram illustrating an example of another ordering search according to the embodiment. As illustrated in FIG. 11, the searching unit 122 gives a score between 0 and 1 including a decimal point in accordance with each condition in the narrow-down condition; calculates a total score using an OR condition and an AND condition; and gives the total score to a name identification target record to be searched. In the example illustrated in FIG. 11, the searching unit 122 adds scores of the application results of the conditions when using the OR condition, whereas the searching unit 122 multiplies scores of the application results of the conditions when using the AND condition. Specifically, because the “zip code=“004-0021”” is “1.0” and the “zip code=NULL” is “0”, the searching unit 122 derives “1.0” (a7) from “1.0+0” using the OR condition. Furthermore, because the “BYGRAM(name=“Tanaka Ichiro”)” is “1.0”, because the “BYGRAM(address=“Sapporo, Hokkaido, AAAA”)” is “0.6”, and because the “complete matching (date of birth=“1958.8.3”)” is “0”, the searching unit 122 derives “1.6” (a8) from “1.0+0.6+0” using the OR conditions. Then, the searching unit 122 multiplies the two derived scores using the AND condition to derive the total score “1.6” (a9). Thereafter, the searching unit 122 sorts the name identification target records in descending order of the total score and searches for records from the top corresponding to, for example, the maximum number of detections k3 defined by the search definition 114. In a similar manner as in the case described above, in the process for sorting the name identification target records in descending order of the total scores, it is possible to exclude a name identification target record whose total score is zero.

### ADVANTAGE OF THE EMBODIMENT

According to the embodiment described above, the information matching apparatus 1 includes the search definition 114 that indicates a condition for excluding candidates, stored in the name identification target records, that are less likely to be similar to or related with each other and includes the grouping definition 113 that indicates a condition for limiting an area of the name identification target records. Then, for values of the name identification items contained in the name identification source record, the information matching apparatus 1 combines, using AND, the search condition defined by the search definition 114 and the grouping condition defined by the grouping definition 113 and creates a narrow-down condition for narrowing down the name identification target records. Then, in accordance with the created narrow-down condition, the information matching apparatus 1 searches the target DB 112 for a name identification target record.

With this configuration, the information matching apparatus 1 combines, using AND, the search condition defined by the search definition 114 and the grouping condition defined by the grouping definition 113; creates a narrow-down condition; and searches for a name identification target record in accordance with the created narrow-down condition. Accordingly, the information matching apparatus 1 integrates the two-step narrow-down process performed using the search condition and the grouping condition. Therefore, it is possible to reduce the number of name identification target records narrowed down in accordance with a condition suitable for the properties of the matching target. Consequently, the information matching apparatus 1 can perform the checking related to the matching at high speed in a large-scale matching process.

Furthermore, the grouping condition defined by the grouping definition 113 is effective when it is used in a case in which a matching result is reliably determined by a value of a specific item using, for example, an operation rule. In contrast, the search condition defined by the search definition 114 is effective when it is used in a case in which a check result of the search item is ambiguous. Accordingly, by combining the grouping condition and the search condition, the condition becomes suitable for narrowing down the properties of the matching target. Specifically, even when many records similar to a name identification source record are stored in the target DB 112, the information matching apparatus 1 narrows down the name identification target in two steps using both the search condition and the grouping condition, thus effectively reducing the number of combinations used to check a name identification source record against name identification target records. Furthermore, even when a large number of name identification target records is narrowed down by the grouping condition, the information matching apparatus 1 narrows down the name identification target in two steps using the search condition, thus effectively reducing the number of combinations used to check a name identification source record against name identification target records.

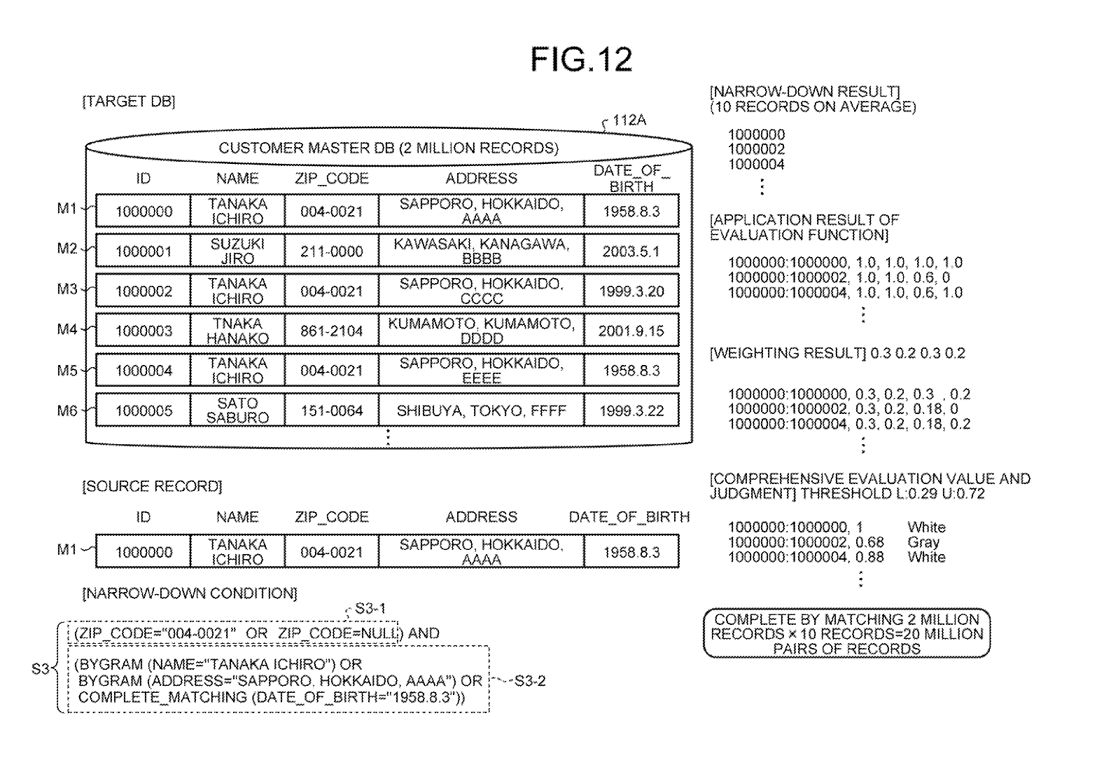

In the following, an advantage of the two-step narrowing down according to the embodiment will be described with reference to FIG. 12. FIG. 12 is a schematic diagram illustrating the effect of two-step narrowing down according to the embodiment. In FIG. 12, as a part of the name identification process for narrowing down records in two steps, an intermediate step of the name identification process performed on a single name identification source record M1 and a result thereof. A customer master DB 112A in the target DB stores therein, for example, 2 million records. For values of the name identification items contained in the name identification source record M1, the narrow-down condition creating unit 121 creates a search condition S3-2 defined by the search definition 114 and a grouping condition S3-1 defined by the grouping definition 113 and combines them using AND. Consequently, the narrow-down condition creating unit 121 creates a narrow-down condition S3 that is used to narrow down the name identification target records. Then, in accordance with the created narrow-down condition S3, the searching unit 122 searches the customer master DB 112A for a name identification target record and stores the search result in the search processing result 132. For example, the searching unit 122 stores, in the search processing result 132 as the result of the two-step narrowing down, an average of 10 records for a single name identification source record M1. In this case, the searching unit 122 stores the name identification target records M1, M3, MS . . . in the search processing result 132. In FIG. 12, only IDs of the searched name identification target records are illustrated.

Then, the matching unit 123 checks the name identification source record M1 against each record that is stored in the search processing result 132 and that corresponds to the name identification target. For example, as an intermediate result for the checking, the matching unit 123 outputs an application result of the evaluation function, a weighting result, and a comprehensive evaluation value for each combination of the name identification source record M1 and each of the name identification target records M1, M3, M5 . . . . Then, after the checking, the matching unit 123 performs the determination, for each combination of the name identification source record M1 and each of the name identification target record M1, M3, M5 . . . , related to the matching and outputs the determination results.

In this way, in the two-step narrowing down process, if it is assumed that the self name identification is performed on 2 million records and that an average of 10 records remains for a single name identification source record as a result of the two-step narrowing down, the checking of 2 million records×10 records=20 million combinations of records is needed. In contrast, if the name identification source records and the name identification target records are checked in a round robin manner, the checking of 2 million records×2 million records=4 trillion combinations of records is needed. Accordingly, the matching unit 123 checks approximately 1/200,000 records compared with a case in which the checking is performed in a round robin manner, thus dramatically speeding up the checking related to the matching. In the matching using the “rough narrowing down”, if the search condition is the same search condition of the two-step narrowing down described with reference to FIG. 12, the checking of 2 million records×100 records=200 million combinations of records is needed. Accordingly, the matching unit 123 checks 1/10 records when compared with a case in which records are matched using the “rough narrowing down”, thus speeding up the checking related to the matching. Furthermore, in the matching using the “grouping window”, if an item identical to that for the grouping condition for the two-step narrowing down is used for the grouping window, which has been described with reference to FIG. 12, the checking of 40 records×40 records×50,000 windows=80 million combinations of records is needed under the best condition in which the number of records in all of the split group is 40. Accordingly, the matching unit 123 checks ¼ records when compared with a case in which the checking is performed on the records using the “grouping window” matching, thus speeding up the checking related to the matching.

Furthermore, according to the embodiment described above, the grouping condition includes a condition, combined using OR, for a record whose name identification item value is the NULL value. With this configuration, even when the target DB 112 includes a large number of NULL values as the name identification item value, the grouping processing unit 122a searches the target DB 112 for a matched record containing the NULL value in the grouping condition in the narrow-down condition and stores it in the grouping processing result 131. Accordingly, because the search processing unit 122b uses a name identification target record containing the NULL value in the name identification item value as the target record for narrowing down records using the search condition in the narrow-down condition, thus preventing the oversight of the matching even when a name identification target record contains the NULL value.

Furthermore, according to the embodiment described above, by using an index previously constructed for the name identification item, the searching unit 122 searches the target DB 112 for a name identification target record. With this configuration, because the searching unit 122 searches the target DB 112 for a name identification target record using the index, thus implementing the two-step narrow-down process at high speed without directly accessing the name identification target record.

Furthermore, according to the embodiment described above, the narrow-down condition creating unit 121 creates a narrow-down condition template in which name identification item value contained in the narrow-down condition is a variable. Then, in accordance with the created template, the narrow-down condition creating unit 121 embeds, in the variable, a value of the item stored in the name identification source record and creates a narrow-down condition. With this configuration, the narrow-down condition creating unit 121 creates a narrow-down condition template and creates a narrow-down condition by using the created template, thus implementing the two-step narrow-down process at higher speed.

Furthermore, according to the embodiment described above, the searching unit 122 performs the scoring in accordance with the degree of matching of each condition contained in the narrow-down condition and extracts a predetermined number of records as the search results in descending order of the scores. With this configuration, the searching unit 122 extracts the predetermined number of records as the search results in the order of high score. Accordingly, even when a significant number of search results is obtained, because low scored records are not included in the search results, the checking of the matching that is subsequently performed can be performed at high speed. Furthermore, it is possible to effectively reduce the possibility of the omission of high score records that need to hold as the matching results when narrowing down the records using the limitation specified by the maximum number of detections.

Furthermore, according to the embodiment described above, the search condition includes a plurality of conditions that is defined by the search definition 114 and is combined using OR. With this configuration, because the narrow-down condition creating unit 121 creates a search condition obtained by combining the conditions using OR, a record that matches with any of the conditions remains in the search results. Accordingly, it is possible to reduce the risk of erroneously excluding candidates stored in the name identification target records that are possibly similar to or related with the name identification source record.

A description has been given with the assumption that items that are stored in the name identification source record and the name identification target record and are associated with each other are set to the grouping item B1 in the grouping definition 113. Accordingly, an item in the name identification source record and an item in the name identification target record may be the same or different each other. Therefore, in addition to the self name identification, the information matching apparatus 1 can speed up the different party name identification in which different structure of items are used for the matching or can speed up the matching using a condition in which a plurality of items in the name identification target is used for one item in the name identification source.

Furthermore, a description has been given with the assumption that items that are stored in the name identification source record and the name identification target record and that are associated with each other are set to the search item K1 in the search definition 114. Accordingly, an item in the name identification source record and an item in the name identification target record may be the same or different each other. Therefore, in addition to the self name identification, the information matching apparatus 1 can speed up the different party name identification in which different structure of items is used for the matching or can speed up the matching using a condition in which a plurality of items in the name identification target is used for one item in the name identification source.

Program, etc.

Furthermore, the information matching apparatus 1 can be implemented by installing the functions of units described above, such as the nonvolatile storing unit 11, the control unit 12, and the volatile storing unit 13 in an information processing apparatus, such as an already known personal computer and a workstation.

The components of each unit illustrated in the drawings are not always physically configured as illustrated in the drawings. In other words, the specific shape of the separate or integrated information matching apparatus 1 is not limited to the drawings; however, all or part of the information matching apparatus 1 may be configured by functionally or physically separating or integrating any of the units depending on various loads or use conditions. For example, the grouping processing unit 122a and the search processing unit 122b may also be integrated as a single unit. In contrast, the narrow-down condition creating unit 121 may be separated by dividing it into a grouping condition creating unit that creates a grouping condition, a search condition creating unit that creates a search condition, and a narrow-down condition creating unit that creates a narrow-down condition from the created grouping condition and the created search condition. Furthermore, various storing units, such as the target DB 112 and the source DB 111, may also be connected via a network as an external unit of the information matching apparatus 1.

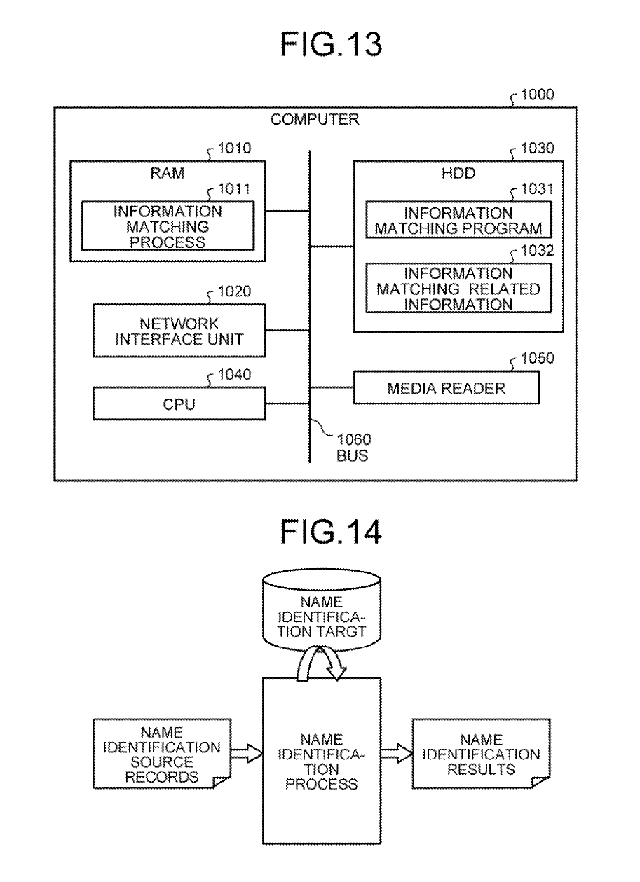

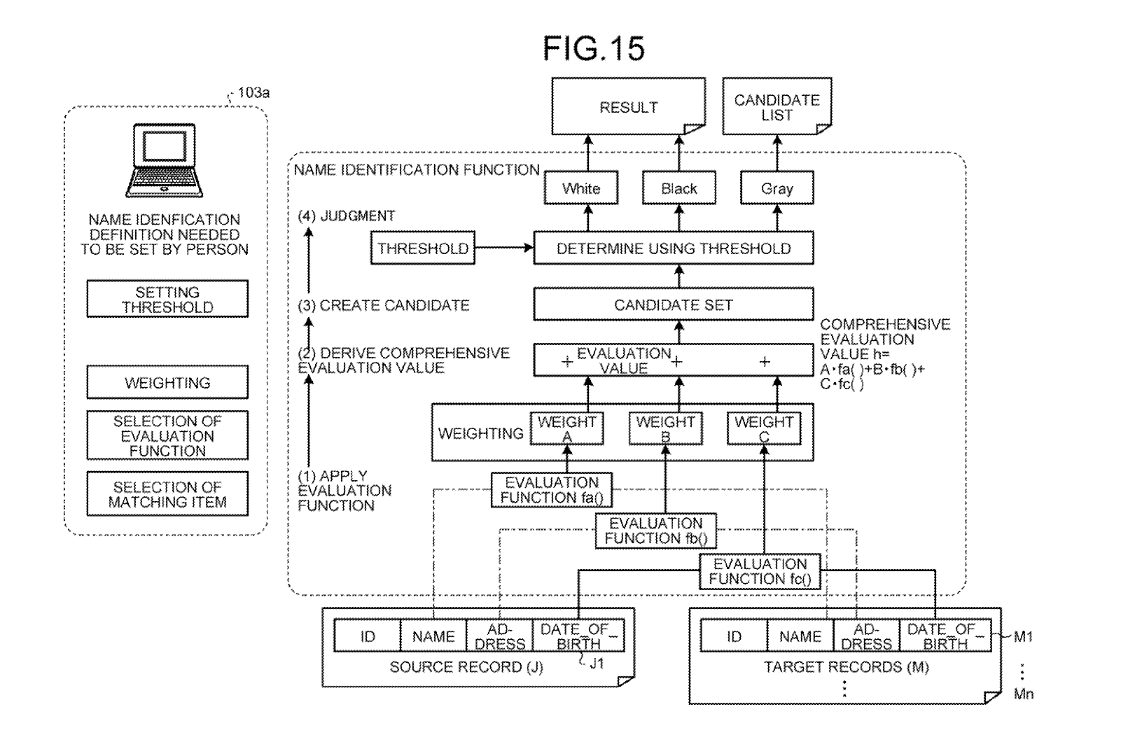

The various processes described in the embodiments can be implemented by a program prepared in advance and executed by a computer system such as a personal computer or a workstation. Accordingly, in the following, a computer that executes an information matching program having the same function as that performed by the control unit 12 in the information matching apparatus 1 illustrated in FIG. 1 will be described as an example using FIG. 13.

FIG. 13 is a block diagram illustrating a computer that executes an information matching program. As illustrated in FIG. 13, a computer 1000 includes a RAM 1010, a network interface unit 1020, an HDD 1030, a CPU 1040, a media reader 1050, and a bus 1060. The RAM 1010, the network interface unit 1020, the HDD 1030, the CPU 1040, and the media reader 1050 are connected by the bus 1060.

The HDD 1030 stores therein an information matching program 1031 having the same function as that performed by the control unit 12 illustrated in FIG. 1. Furthermore, the HDD 1030 stores therein information matching related information 1032 that corresponds to the target DB 112, the name identification source DB 111, the grouping definition 113, and the search definition 114 illustrated in FIG. 1.

The CPU 1040 reads the information matching program 1031 from the HDD 1030 and loads it in the RAM 1010, and thus the information matching program 1031 functions as an information matching process 1011. Then, the information matching process 1011 appropriately loads, in an area of the RAM 1010 appropriately allocated to the information matching process 1011, information or the like that is read from the information matching related information 1032 and executes various data processes on the basis of the loaded data or the like.

even when the information matching program 1031 is not stored in the HDD 1030, the media reader 1050 reads the information matching program 1031 from a medium or the like that stores therein the information matching program 1031. Examples of the media reader 1050 include a CD-ROM or an optical disk. The network interface unit 1020 is connected to an external unit via a network in a wired or wireless manner.

The information matching program 1031 is not always stored in the HDD 1030. For example, the computer 1000 may reads the information matching program 1031 stored in the media reader 1050, such as a CD-ROM, and executes the information matching program 1031. Alternatively, the information matching program 1031 may also be stored in another computer (or a server) connected to the computer 1000 via a public circuit, the Internet, a LAN, a wide area network (WAN), or the like. In such a case, the computer 1000 reads and executes the information matching program 1031 via the network interface unit 1020.

According to an aspect of the present invention, checking related to the matching can be widely used at high speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information matching apparatus comprising:
a processor;
a check target database that stores therein the records; and
a memory, wherein the processor executes:
creating a narrow-down condition for narrowing down check target records by combining, using a logical multiplication in accordance with values of check items contained in a check source record, a search condition defined by a search definition indicating a condition for excluding candidates that are stored in check target records and that are less likely to have a similarity to or a relationship with a check source record, and a grouping condition defined by a grouping definition indicating a condition for limiting a checking area of the check target records; and
searching, in accordance with the narrow-down condition created at the creating, the check target database for a check target record.

2. The information matching apparatus according to claim 1, wherein the grouping condition includes a condition combined with, using a logical addition, a condition in which a value of a check item does not contain information.

3. The information matching apparatus according to claim 1, wherein the searching searches the check target database for the check target records by using an index that is previously constructed for the check items.

4. The information matching apparatus according to claim 1, wherein, in accordance with a narrow-down condition template created such that the values of the check items contained in the narrow-down condition are variables, the creating a narrow-down condition substitutes values contained in the check source record for the variables to create the narrow-down condition.

5. The information matching apparatus according to claim 1, wherein the searching performs scoring in accordance with the degree of matching of each condition contained in the narrow-down condition and extracts a predetermined number of records as search results in descending order of scores.

6. The information matching apparatus according to claim 1, wherein the search condition includes a condition in which a plurality of conditions defined by the search definition are combined using the logical addition.

7. A non-transitory computer readable storage medium having stored therein an information matching program causing an information matching apparatus to execute a process comprising:
creating, in accordance with values of check items contained in a check source record, a grouping condition that is defined by a grouping definition indicating a condition for limiting a checking area of records stored in a check target database that stores therein a plurality of records;
creating, in accordance with values of check items contained in a check source record, a search condition that is defined by a search definition indicating a condition for excluding candidates that are stored in check target records and that are less likely to have a similarity to or a relationship with the check source record;
combining, using a logical multiplication, the created grouping condition and the created search condition to create a narrow-down condition that narrows down the check target records; and
searching the check target database for a check target record in accordance with the created narrow-down condition.

8. An information matching method performed by an information matching apparatus, the information matching method comprising:
creating, in accordance with values of check items contained in a check source record, a grouping condition that is defined by a grouping definition indicating a condition for limiting a checking area of records stored in a check target database that stores therein a plurality of records;
creating, in accordance with values of check items contained in a check source record, a search condition that is defined by a search definition indicating a condition for excluding candidates that are stored in check target records and that are less likely to have a similarity to or a relationship with the check source record;
combining, using a logical multiplication, the created grouping condition and the created search condition to create a narrow-down condition that narrows down the check target records; and
searching the check target database for a check target record in accordance with the created narrow-down condition.
